(19) United States
(12) Patent Application Publication
(10) Pub. No.: US 2013/0173276 A1
(43) Pub. Date: Jul. 4, 2013

(54) Animal Operations Data Management System and Method

(71) Applicant: Norman Mullin, Amarillo, TX (US)

(72) Inventor: Norman Mullin, Amarillo, TX (US)

(73) Assignee: ENVIRO-AG ENGINEERING, Amarillo, TX (US)

(21) Appl. No.: 13/733,883

(22) Filed: Jan. 3, 2013

Related U.S. Application Data
(60) Provisional application No. 61/582,732, filed on Jan. 3, 2012.

(51) Int. Cl. G06Q 10/04

(52) U.S. Cl. CPC G06Q 10/04
USPC 705/1.1

(57) ABSTRACT

A server is disclosed comprising a storage device, a processors, a memory, and communication hardware components. Said server is capable of receiving an animal operations data record event from a client device related to a concentrated animal feeding operation; recording to said storage device said animal operations data record; transmitting a first portion of said animal operations data record to a device application; processing said animal operations data record into a user disposition data with said device application; transmitting a user disposition record to said storage device in said server; and storing said user disposition record as one or more event records in said storage device.

### BACKGROUND

This disclosure relates generally to an animal operations data management system and method.

Prior types of animal operations data management systems comprise pen and paper tracking and forecasting of CAFO data.

None of the prior approaches, taken either singularly or in combination, is seen to describe the instant disclosure as claimed. Accordingly, an improved animal operations data management system and method would be advantageous.

### SUMMARY

Three embodiments of an animal operations data management system are disclosed. A first embodiment is disclosed comprising a server. Said server comprising a storage device, a processors, a memory, and communication hardware components. Said server is capable of receiving an animal operations data record event from a client device related to a concentrated animal feeding operation; recording to said storage device said animal operations data record; transmitting a first portion of said animal operations data record to a device application; processing said animal operations data record into a user disposition data with said device application; transmitting a user disposition record to said storage device in said server; and storing said user disposition record as one or more event records in said storage device.

A second embodiment is disclosed comprising a method for animal operations data management. Said method comprising: receiving an animal operations data record event from a client device related to a concentrated animal feeding operation; recording to a storage device said animal operations data record; transmitting a first portion of said animal operations data record to a device application; processing said animal operations data record into a user disposition data with said device application; transmitting a user disposition record to said storage device in a server; and storing said user disposition record as one or more event records in said storage device.

A third embodiment is disclosed comprising a computer usable medium having a computer readable program code embodied therein, wherein the computer readable program code is adapted to be executed to implement the method disclosed supra.

### BRIEF DESCRIPTION OF THE DRAWINGS

FIG. 1 illustrates an animal operations data management system.

FIGS. 2A and 2B illustrate mobile device and computer.

FIG. 2C illustrates an address space within interface devices.

FIG. 3A illustrates data flow between interface devices and server during the recording, processing, and storing of animal operations data.

FIG. 3B illustrates data flow between server and interface devices during a data management process.

FIG. 4A illustrates an initial registration screen of device application.

FIG. 4B illustrates a registration screen of device application.

FIG. 4C illustrates a nutrient management plan screen.

FIGS. 4D and 4E illustrate two portions of a samples screen.

FIG. 5A illustrates an overview of an application window.

FIG. 5B illustrates an embodiment of a navigation system of application window.

FIG. 5C illustrates navigation system with wastewater application a plurality of submenu options.

FIG. 6A illustrates a time on/off view.

FIG. 6B illustrates time on/off view with after planned application event chart.

FIG. 7 illustrates said before planned application event chart.

FIGS. 8A and 8B illustrate two views of after planned application event chart.

FIG. 9 illustrates a GHAF view of wastewater application.

FIG. 10 illustrates a meter readings view of wastewater application.

FIG. 11 illustrates an off-site wastewater view of wastewater application.

FIG. 12A illustrates navigation system with manure comprising a plurality of submenu options.

FIG. 12B illustrates manure application event view.

FIG. 12C illustrates manure haul-off screen.

FIG. 13A illustrates navigation system with slurry comprising a plurality of submenu options.

FIG. 13B illustrates new slurry application event screen.

FIG. 13C illustrates a slurry haul-off screen.

FIG. 14 illustrates a parlor meter readings screen.

FIGS. 15A and 15B illustrate two views of a calendar view.

FIG. 15A illustrates a portion of calendar data entry and one embodiment of sidebars.

FIG. 15B illustrates a portion of calendar data entry.

FIG. 16A illustrates daily log.

FIGS. 16B and 16C illustrate a top portion and lower portion of said weekly log 1507.

FIG. 16D illustrates monthly log.

FIGS. 16E and 16F illustrate an overview and detailed view of pond marker readings.

FIG. 17 illustrates a headcount entry view.

FIG. 18A illustrates additional logs with a plurality of submenu options.

FIGS. 18B and 18C illustrate an overview and detailed view of annual review.

FIG. 18B illustrates years.

FIG. 18C illustrates annual inspection checklist.

FIGS. 18D and 18E illustrate two portions of employee training

FIG. 18D illustrates new training event.

FIG. 18E illustrates prior training report.

FIG. 18F illustrates liner maintenance.

FIG. 18G illustrates spills.

FIGS. 19A-19L can comprise a plurality of reports provided to users of animal operations data management system.

FIG. 19A illustrates a nutrient management report view.

FIG. 19B illustrates a pond level summary view.

FIG. 19C illustrates a wastewater records report.

FIG. 19D illustrates a samples summary view.

FIG. 19E illustrates a manure by field records view.

FIG. 19F illustrates a slurry by field records view

FIG. 19G illustrates an off-site application report view.

FIG. 19H illustrates a daily log report view.

FIG. 19I illustrates a weekly log report view.

FIG. 19J illustrates a monthly log report view.

FIG. 19K illustrates an annual log report view.

FIG. 19L illustrates a headcount report view.

### DETAILED DESCRIPTION

Described herein is an animal operations data management system and method. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

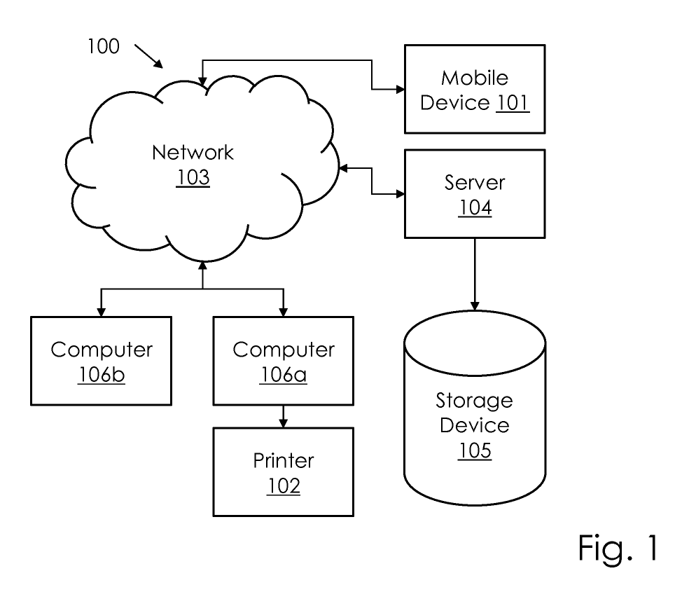

FIG. 1 illustrates an animal operations data management system 100. In one embodiment, an animal operations data management system and method can comprise said animal operations data management system 100. In one embodiment, said animal operations data management system 100 can comprise a mobile device 101 that can capture animal operations data at a field location. In one embodiment, said animal operations data management system 100 can comprise a plurality of said mobile device 101. In one embodiment, said mobile device 101 can also connect to a network 103, which can connect to a one or more servers 104. In one embodiment, a printer 102 can be hardwired to said mobile device 101. In another embodiment, said printer 102 can connect to said mobile device 101 via network 103. Said network 103 can be a local area network (LAN), a wide area network (WAN), a piconet, or a combination of LANs, WANs, or piconets. One illustrative LAN is a network within a single business. One illustrative WAN is the Internet. In one embodiment, said server 104 represents at least one, but can be many servers, each connected to said network 103. Said server 104 can connect to a storage device 105. Said storage device 105 can connect directly to said server 104, as shown in FIG. 1, or may exist remotely on said network 103. In one embodiment, said storage device 105 can comprise any suitable long-term or persistent storage device and, further, may be separate devices or the same device and may be collocated or distributed (interconnected via any suitable communications network). Said animal operations data management system 100 can also include a one or more client computers, connected to said network 103. In one embodiment, said one or more client computers can comprise a computer 106a and a computer 106b. In one embodiment, said printer 102 can connect to said computer 106b. In one embodiment, said one or more client computers each can include, but is not limited to, a laptop, desktop, workstation, server, mainframe, terminal, and/or one among a one or more of said mobile device 101.

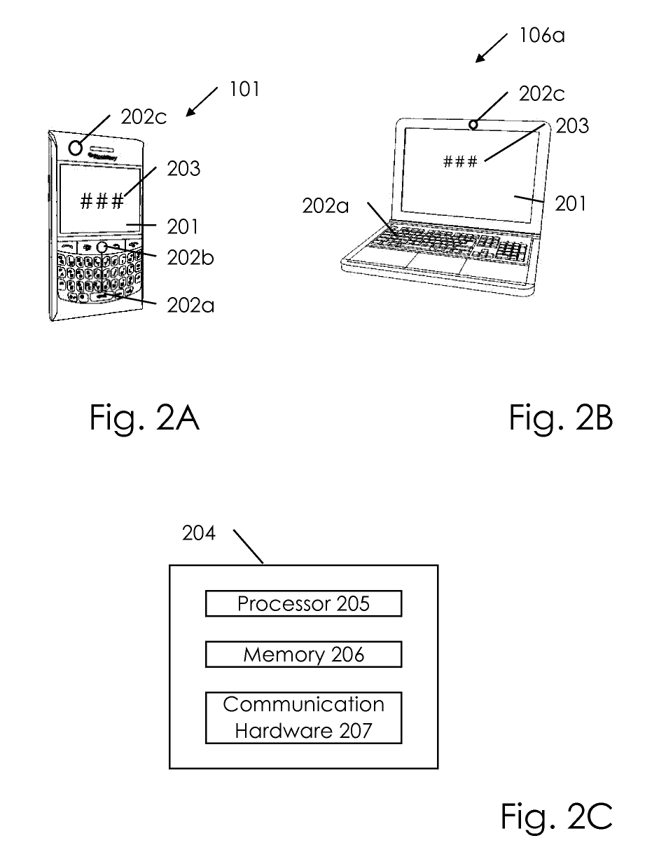

FIGS. 2A and 2B illustrate said mobile device 101 and said computer 106a. For ease of description, said mobile device 101 and/or said one or more client computers will hereafter be referred to as a grouping under the term an interface device, as either can be capable of interacting with said animal operations data management system 100. Mobile device 101 can comprise, but is not limited to, a screen 201 and a one or more input devices. Likewise, each of one or more client computers can comprise screen 201 and said one or more input devices. In one embodiment, said input devices 202 can comprise a keyboard 202a, a trackball 202b, a one or more cameras 202c, and/or a wireless reader (such as an RFID reader). In one embodiment, said screen 201 can comprise a touch screen among said one or more input devices of said screen 201 and/or said one or more client computers.

Said animal operations data management system 100 can comprise an animal operations data 203. In one embodiment, said animal operations data 203 can comprise data related to the management of animal operations. In one embodiment, said animal operations data 203 can comprise data related to Concentrated Animal Feeding Operations (hereafter “CAFO”, or “CAFO data”). The term animal is understood to include, but not be limited to, bovine, horses, swine, dairy cattle, beef cattle, and/or poultry.

In one embodiment, said interface devices can be used to input and view said animal operations data 203. In one embodiment, said animal operations data 203 can be input into said mobile device 101 by taking pictures with one of cameras 202c. In one embodiment, said animal operations data 203 can be input by typing on keyboard 202a. Many other data entry means for devices similar to said mobile device 101 are well known and herein also possible with animal operations data 203. In one embodiment, mobile device 101 can comprise an iPhone®, a BlackBerry®, a tablet device, a smartphone, or similar. In one embodiment, one or more client computers can comprise a laptop computer, a desktop computer, or similar.

FIG. 2C illustrates an address space 204 within said interface devices. Each among said mobile device 101, said one or more client computers and said server 104 can comprise an embodiment of address space 204. Said address space 204 can comprise a one or more processors 205, a memory 206, and a one or more communication hardware components 207. In one embodiment, said animal operations data 203 can be sent to said processors 205; wherein, said processors 205 can perform processes on said animal operations data 203 according to an application stored in said memory 206, as discussed further below. Said process can include storing said animal operations data 203 into said memory 206, verifying said animal operations data 203 conforms to a one or more preset standards, or ensuring a required set among said required animal operations data 203 has been gathered for said animal operations data management system and method. In one embodiment, said animal operations data 203 can include data which said interface devices can populate automatically, such as a date and a time, as well as data entered manually. Once a portion of gathering data has been performed said animal operations data 203 can be sent to said communication hardware components 207 for communication over said network 103. Said communication hardware components 207 can include a network transport processor for packetizing data, communication ports for wired communication, or an antenna for wireless communication. In one embodiment, said animal operations data 203 can be collected in interface devices and delivered to said server 104 through said network 103.

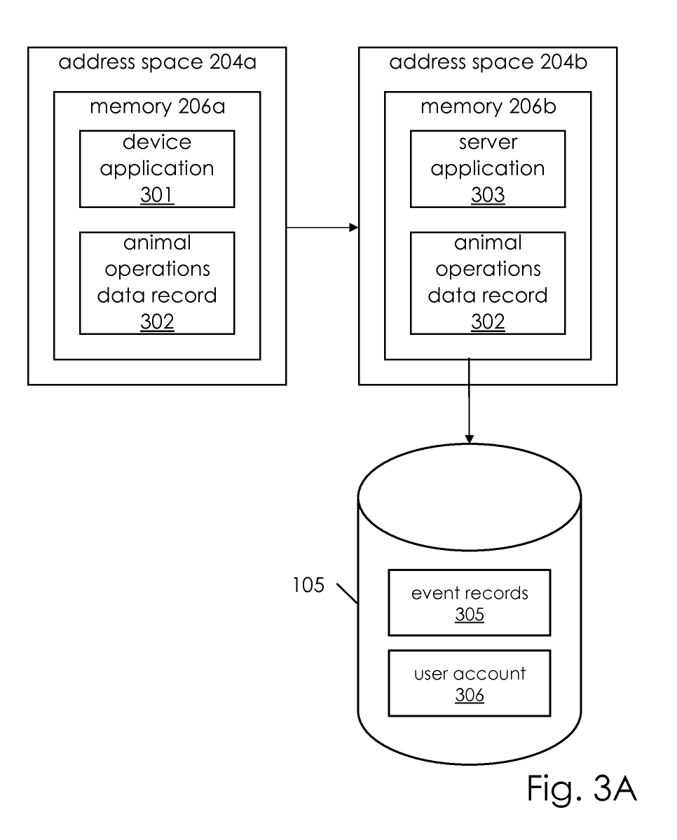

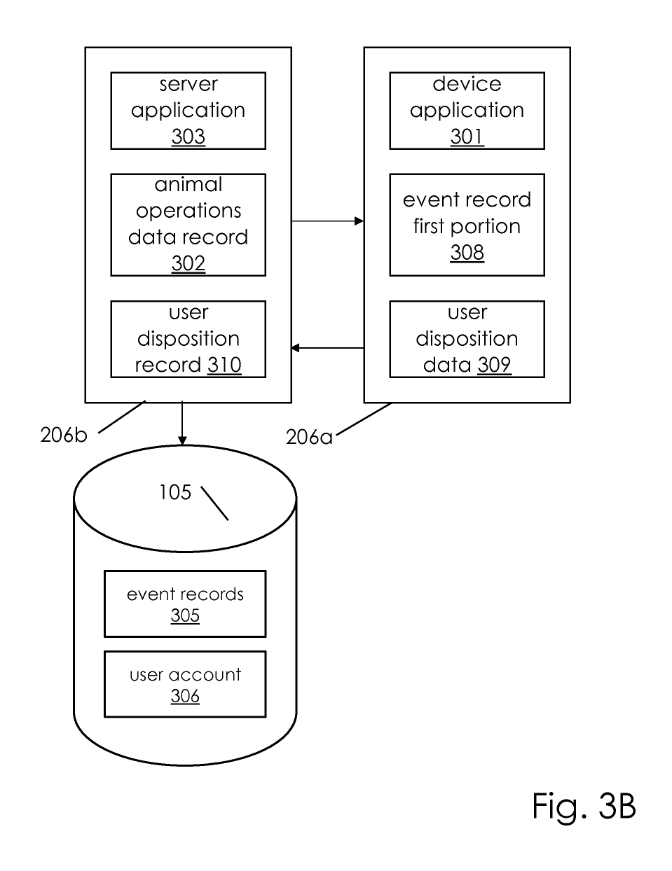

FIG. 3A illustrates a data flow between said interface devices and said server 104 during the recording, processing, and storing of said animal operations data 203. A user of said animal operations data management system and method can capture said animal operations data 203 with said one or more of interface devices. In one embodiment, one among said interface devices can comprise an address space 204a and a memory 206a; and said server 104 can comprise an address space 204b and a memory 206b. In one embodiment, executing a device application 301 stored in said memory 206a can display a series of data input fields (not illustrated here) capable of accepting said animal operations data 203 from said user. Further, in one embodiment, said device application 301 can: display said animal operations data 203 to said screen 201; store said animal operations data 203 in said memory 206a; and/or transmit said animal operations data 203 to said server 104. Further, in one embodiment, said device application 301 can process at least a portion of said animal operations data 203 and form an animal operations data record 302. In one embodiment, said animal operations data record 302 can be sent to said server 104.

In one embodiment, said device application 301 can comprise a browser application. In one embodiment, said browser application can comprise a web-based application, as described below. In one embodiment, at least a portion of said animal operations data 203 can be sent to said server 104 where a server application 303 can exist in said memory 206b. In one embodiment, said server application 303 can process said animal operations data record 302. Said animal operations data record 302 can be distinguished using unique identifiers, which are described in patent application Ser. No. 12/648,850, titled Electronic Citation Recording, Processing and Storing, which is hereby incorporated by reference. In one embodiment, said server application 303 can perform various tasks including verifying that said animal operations data record 302 is complete, storing said animal operations data record 302 in a one or more event records 305 in said storage device 105. In one embodiment, said storage device 105 can comprise a portion of address space 204b or a separate storage medium. In one embodiment, server application 303 can associate event records 305 with a user account 306. In one embodiment, server application 303 is a web-based application capable of being accessed by said users on network 103, as discussed infra.

FIG. 3B illustrates data flow between server 104 and interface devices during a data management process. In one embodiment, interface devices can be used in said data management process. In one embodiment, said device application 301 can comprise a web browser, an app on mobile device 101, an application on one or more client computers, or similar. In one embodiment, said device application 301 can interface with said server application 303 to let said user log into user account 306. In one embodiment, said data management process can comprise managing said animal operations data 203 with said device application 301 and said server application 303. In one embodiment, said animal operations data management system 100 can comprise said data management process. In one embodiment, said server application 303 can retrieve said animal operations data record 302 from said event records 305 and send said animal operations data record 302 to said device application 301 for management. In one embodiment, said device application 301 can receive a portion of said animal operations data record 302 from said server application 303 as an event record first portion 308. In one embodiment, said event record first portion 308 can be accessed after said user account 306 is loaded and verified. In one embodiment, said event record first portion 308 can be processed, reviewed, managed or similar within said device application 301. In one embodiment, said event record first portion 308 can be modified into a user disposition data 309. In one embodiment, said user disposition data 309 can be transmitted back to said memory 206b as a user disposition record 310. In one embodiment, said user disposition record 310 can be recorded as a portion of said event records 305.

In one embodiment, a one or more of said user disposition records 310 can be collected automatically through an automated sensor and/or data collection system, as is known in the art. In another embodiment, said user disposition record 310 can be manually entered by an individual.

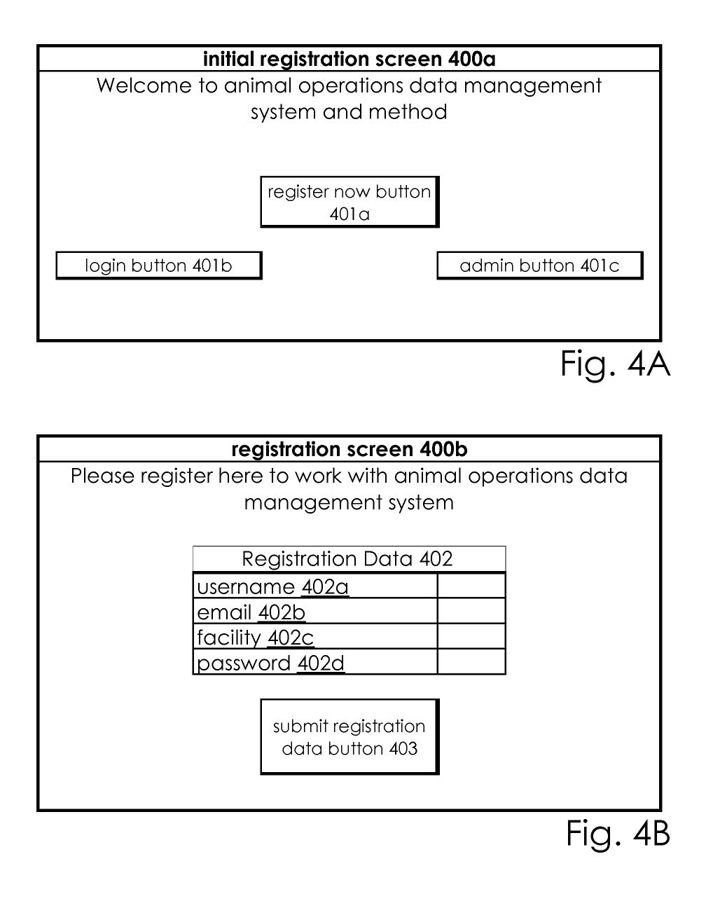

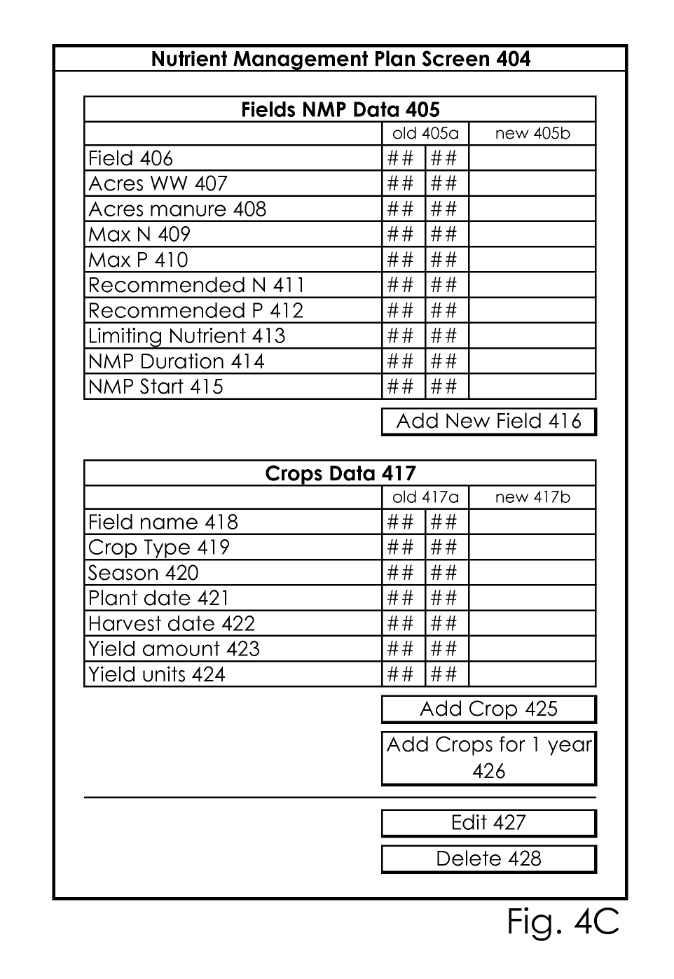

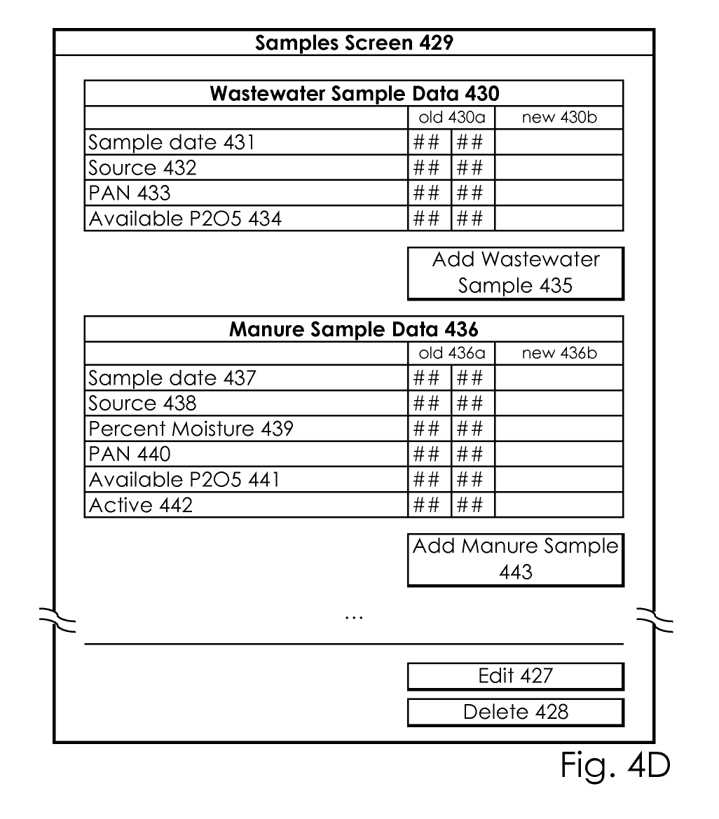

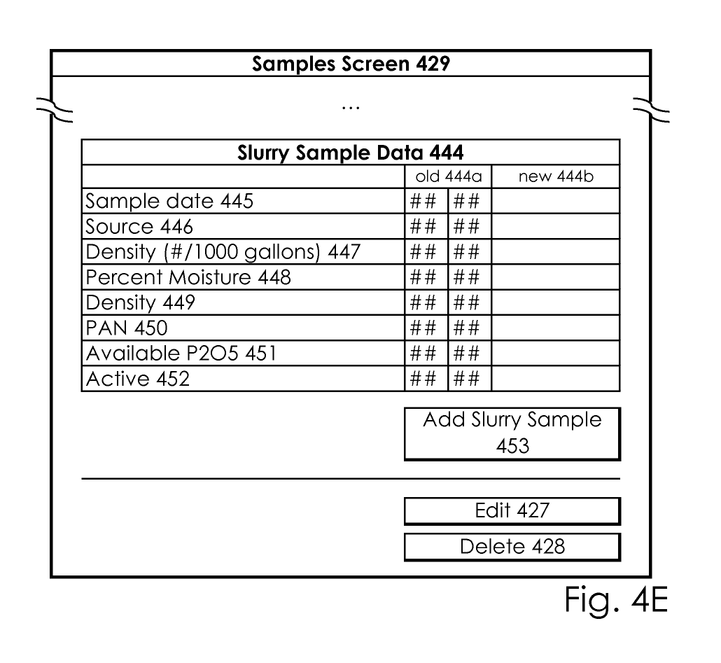

FIG. 4A illustrates an initial registration screen 400a of said device application 301. In one embodiment, said initial registration screen 400a can comprise a register now button 401a, a login button 401b and an admin button 401c. In one embodiment, a new user can click on said register now button 401a to create a new record within said user account 306 for said new user. In one embodiment, a returning user can click on said login button 401b to access an existing record within said user account 306. In one embodiment, an administrator can click on said admin button 401c to access a set of administrative tools within said animal operations data management system 100.

FIG. 4B illustrates a registration screen 400b of said device application 301. In one embodiment, said registration screen 400b can comprise a one or more registration data 402 and a submit registration data button 403. Said registration data 402 can comprise a username 402a, an email address 402b, one or more facilities 402c and a password 402d. In one embodiment, said registration data 402 can comprise a portion of said user account 306 for individual users of said animal operations data management system 100. For example, in one embodiment, said username 402a can comprise a unique identifier for each of said users. In one embodiment, said facilities 402c can comprise a one or more locations being managed with said animal operations data management system and method. In one embodiment, each unique record among said username 402a can be assigned to a one or more facilities 402c. Further, in one embodiment, each said facilities 402c can be managed by a one or more users represented by said username 402a. That is, in one embodiment, said username 402a and said facilities 402c can comprise a many to many relationship. In one embodiment, each of said registration data 402 on said registration screen 400b can comprise a text input each capable of receiving a text entry. In one embodiment, said facilities 402c can comprise a drop down field wherein a single facility can be selected. In another embodiment, said facilities 402c can comprise a list of options wherein a plurality of facilities can be selected. In one embodiment, said password 402d can comprise a duplicate input to verify the correct entry of said password 402d as is well known in the art. In one embodiment, one or more among said registration data 402 can require approval by an administrator prior to being used by said animal operations data management system 100. For example, in one embodiment, said administrator will assign and/or approve of said facilities 402c as entered into said registration screen 400b.

In one embodiment, a user of said animal operations data management system and method can register by opening said device application 301, clicking on said register now button 401, filling out said registration data 402, and clicking on said submit registration data button 403. In one embodiment, said registration data 402 can be used to form said user account 306.

FIG. 4C illustrates a nutrient management plan screen 404. In one embodiment, said nutrient management plan screen 404 can be used to manage variables relevant to a nutrient management plan (“NMP”) within said animal operations data management system and method. In one embodiment, said nutrient management plan screen 404 can comprise a fields NMP data 405 and a crops data 417.

Generally, nutrient management can comprise a system used by farmers to manage the amount, form, placement, and timing of the application of nutrients (whether as manure, commercial fertilizer, or other form of nutrients) to plants. A purpose for said NMP can comprise supplying plant nutrients for optimum forage and crop yields, to minimize nonpoint source pollution (runoff of pollutants to surface water) and contamination of groundwater, and to maintain and/or improve the condition of soil. In one embodiment, said NMP is a set of conservation practices designed to use fertilizer and/or manure to effectively provide needed crop nutrients while protecting against the potential adverse impacts of manure, erosion and organic byproducts on water quality. When such a plan is designed for animal feeding operations (AFO or CAFO) it may be termed a “manure management plan.” The plans may address soil testing, plant tissue testing, manure testing, erosion control practices, according to the soil pH the recommend dose may be varying, and timing of fertilizer/manure application. In the United States some regulatory agencies recommend or require that farms implement these plans, in order to prevent water pollution. The U.S. Natural Resources Conservation Service (NRCS) has published guidance documents on preparing a comprehensive nutrient management plan (CNMP) for AFOs.

In one embodiment, said fields NMP data 405 can comprise data on said NMP for a one or more fields; that is, said fields NMP data 405 can be organized on a field by field basis. In one embodiment, said fields NMP data 405 can comprise a plurality of records each comprising a field 406, an acres WW 407, an acres manure 408, a max N 409, a max P 410, a recommended N 411, a recommended P 412, a limiting nutrient 413, a NMP duration 414 and a NMP start 415. Said acres WW 407 can comprise a volume of waste water (“WW”) applied to said field 406. Said acres manure 408 can comprise a volume of manure applied to field 406. Said max N 409 and said max P 410 can comprise a maximum allowed volume of nitrogen and P₂O₅, respectively, for said field 406. Likewise, said recommended N 411 and said recommended P 412 can comprise a recommended volume of nitrogen and P₂O₅, respectively, for said field 406. Said limiting nutrient 413 can comprise a nutrient, among N and P₂O₅, which is most likely to surpass said max N 409 or said max P 410 first. Said NMP duration 414 can comprise a period of time for which an NMP is in effect for said field 406. Said NMP start 415 can comprise a start date for said NMP for said field 406.

Said Crops data 417 can comprise data regarding crops planted and managed by said NMP. Said crops data 417 can comprise a plurality of records each comprising a field name 418, a crop type 419, a season 420, a plant date 421, a harvest date 422, a yield amount 423 and a yield units 424. In one embodiment, said field name 418 can comprise a one or more of said field 406. In one embodiment, said crop type 419 can comprise a type of agricultural crop planted on field name 418. In one embodiment, said season 420 can comprise the planting season in which said crop type 419 is planted on said field name 418. In one embodiment, said plant date 421 can comprise a date on which said crop type 419 has been planted. In one embodiment, said harvest date 422 can comprise a date planed or having occurred upon which a harvest of said crop type 419 happens. In one embodiment, said yield amount 423 can comprise a metric of how much said crop type 419 is harvested per unit. In one embodiment, said yield units 424 can comprise a number of said units of said crop type 419 harvested.

In one embodiment, said fields NMP data 405 can be entered into said nutrient management plan screen 404 and recorded into said event records 305 by pressing an add new field button 416. In one embodiment, said fields NMP data 405 can comprise an old 405a and a new 405b. In one embodiment, said old 405a can comprise fields NMP data 405 entered previously. In one embodiment, said new 405b can comprise a set of data entry fields capable of receiving new data for said fields NMP data 405.

In one embodiment, said crops data 417 can be entered into said nutrient management plan screen 404 and recorded into said event records 305 by pressing an add crop button 425. In one embodiment, said crops data 417 can comprise an old 417a and a new 417b. In one embodiment, said old 417a can comprise said crops data 417 entered previously. In one embodiment, said new 417b can comprise a set of data entry fields capable of receiving new data for said crops data 417.

Said nutrient management plan screen 404 can comprise an edit button 427 and a delete button 428. In one embodiment, one record of said old 405a and/or said old 417a can be modified by clicking or tapping said record, and then said edit button 427 to edit said record or then said delete button 428 to delete said record.

FIGS. 4D and 4E illustrate two portions of a samples screen 429. FIG. 4D can comprise a top portion of said samples screen 429 and FIG. 4E can comprise a lower portion of said samples screen 429. In one embodiment, said NMP can comprise testing wastewater, manure and slurry applied within said NMP. In one embodiment, said samples screen 429 can comprise a wastewater sample data 430, a manure sample data 436 and a slurry sample data 444.

In one embodiment, said wastewater sample data 430 can comprise a set of records each comprising data related to the condition and makeup of wastewater at from a particular location. Said wastewater sample data 430 can comprise a sample date 431, a source 432, a PAN 433 and an available P₂O₅ 434. In one embodiment, said sample date 431 can comprise a date upon which a sample of wastewater was collected for analysis. In one embodiment, said source 432 can comprise a reservoir of wastewater from which said sample was collected. In one embodiment, said PAN 433 can comprise a measurement of N within said source 432 in pounds per acre-in; wherein, pounds per acre-in Nitrogen can be abbreviated “PAN”. In one embodiment, said available P₂O₅ 434 can comprise an amount of P₂O₅ available. In one embodiment, said wastewater sample data 430 can comprise an old 430a and a new 430b. In one embodiment, said new 430b can be entered into said samples screen 429 and recorded to said event records 305 by clicking an add wastewater sample button 435. In one embodiment, one of said old 430a can be modified by selecting said one of said old 430a and then selecting said edit button 427 or said delete button 428, as discussed supra.

In one embodiment, said manure sample data 436 can comprise a set of records each comprising data related to the condition of manure at a particular location. Manure sample data 436 can comprise a sample date 437, a source 438, a percent moisture 439, a PAN 440, an available P₂O₅ 441, and an active 442. In one embodiment, said sample date 437 can comprise a date upon which a sample of manure was collected for analysis. In one embodiment, said source 438 can comprise a source of said manure. In one embodiment, said percent moisture 439 can comprise a measurement of a moisture content of said manure. In one embodiment, said PAN 440 can comprise a similar measurement as PAN 433. In one embodiment, said available P₂O₅ 441 can comprise a similar measurement as said available P₂O₅ 434. In one embodiment, said active 442 can comprise a flag in manure sample data 436 for determining whether said source 438 is active or inactive as a source of manure. In one embodiment, said manure sample data 436 can comprise an old 436a and a new 436b. In one embodiment, said new 436b can be entered into said samples screen 429 and recorded to said event records 305 by clicking an add manure sample button 443. In one embodiment, one of said old 436a can be modified by selecting said one of said old 436a and then selecting said edit button 427 or said delete button 428, as discussed supra.

In one embodiment, said slurry sample data 444 can comprise a set of records each comprising data related to the condition of slurry at a particular location. In one embodiment, said slurry sample data 444 can comprise a sample date 445, a source 446, a density 447, a percent moisture 448, a density 449, a PAN 450, an available P₂O₅ 451 and an active 452. In one embodiment, many of said slurry sample data 444 can have similar characteristics to said manure sample data 436. For example, in one embodiment: said sample date 445 can correlate to said sample date 437; said source 446 can correlate to said source 438; said percent moisture 448 can correlate to said percent moisture 439; said PAN 450 can correlate to said PAN 440; available said P₂O₅ 451 can correlate to available said available P₂O₅ 441; and said active 452 can correlate to said active 442. In one embodiment, said density 447 can comprise a density of slurry in said source 446 measured in pounds per 1000 gallons. In one embodiment, said slurry sample data 444 can comprise an old 444a and a new 444b. In one embodiment, said new 444b can be entered into said samples screen 429 and recorded to said event records 305 by clicking an add slurry sample button 453. In one embodiment, one of said old 444a can be modified by selecting said one said of old 444a and then selecting said edit button 427 or said delete button 428, as discussed supra.

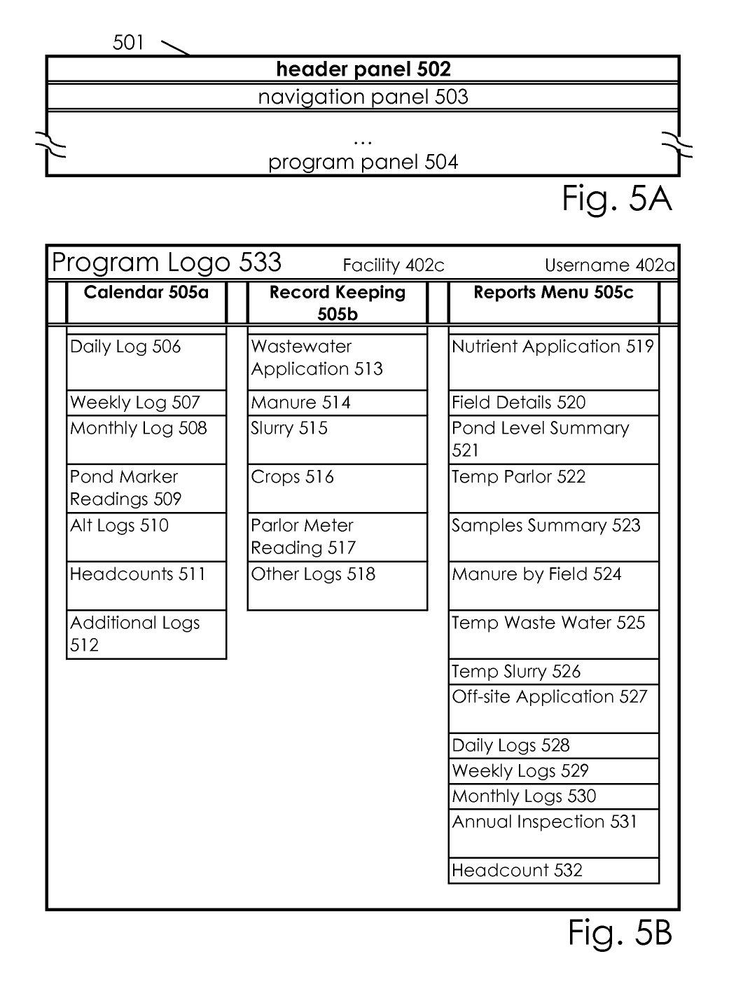

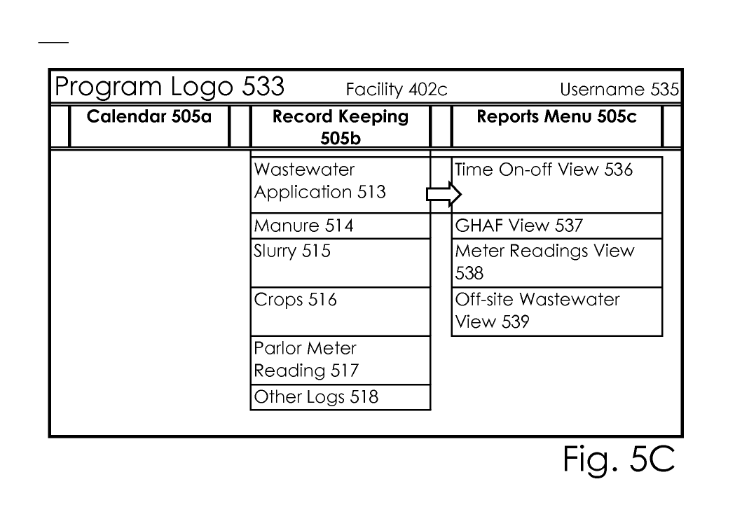

FIG. 5A illustrates an overview of an application window 501. Said application window 501 can comprise a header panel 502, a navigation panel 503 and a program panel 504. In one embodiment, said header panel said header panel 502 can comprise a top portion of said application window 501 capable of displaying general information regarding said animal operations data management system 100. In one embodiment, said navigation panel 503 can comprise a middle portion of said application window 501 and can comprise a means of navigating through a plurality of screens within said animal operations data management system 100. In one embodiment, said program panel 504 can comprise a general use portion of said application window 501 for interacting with different portions of said animal operations data management system 100.

FIG. 5B illustrates an embodiment of a navigation system 505 of said application window 501. In one embodiment, said navigation system 505 can be used to navigate through different portions of said device application 301, as is well known in the art. In one embodiment, said navigation system 505 can comprise a one or more top categories comprising a calendar 505a, a record keeping 505b, and a reports menu 505c. In one embodiment, said calendar 505a can comprise a daily log 506, a weekly log 507, a monthly log 508, a pond marker readings 509, an alt logs 510, a headcounts 511, and an additional logs 512. In one embodiment, said record keeping 505b can comprise a wastewater application 513, a manure 514, and a slurry 515. In one embodiment, said reports menu 505c can comprise a nutrient application 519, a field details 520, a pond level summary 521, a parlor 522, a samples summary 523, a manure by field 524, a wastewater 525, a slurry 526, an off-site application 527, a daily logs 528 a weekly logs 529, a monthly logs 530, an annual inspection 531, and a headcount 532. In one embodiment, when a mouse hovers over or clicks one of said calendar 505a, said record keeping 505b and/or said reports menu 505c, a set of submenus display below said navigation system 505, as is well known for navigating web applications and websites. Each of a plurality of subpages referred to by said navigation system 505 can comprise another set of subpages, and so on. In one embodiment, said navigation system 505 displays above every page of said animal operations data management system and method when a user is registered and logged-in.

In one embodiment, said device application 301 can comprise said header panel 502, said navigation panel 503 and said program panel 504. Said header panel 502 can comprise a program logo 535, a one of said facilities 402c and said username 402a. In one embodiment, said program logo 535 can comprise a marketing name of said device application 301. In one embodiment, said one of said facilities 402c can a facility being managed by said animal operations data management system 100 and associated with said username 402a. In one embodiment, when a user with said username 402a logs into said animal operations data management system 100, a default of said facilities 402c can be loaded automatically. In another embodiment, when said user logs in, said user can select one of said facilities 402c to manage. In one embodiment, one or more of said facilities 402c can be assigned to one or more among said username 402a. In one embodiment, said device application 301 can be arranged with said header panel 502 above said navigation panel 503, and said navigation panel 503 above said program panel 504.

In one embodiment, said navigation panel 503 can comprise said navigation system 505. In one embodiment, said navigation system 505 can dropdown when triggered by hovering or clicking thereupon, as is well known in the art. For example, in one embodiment, triggering said calendar 505a can cause a dropdown menu to appear containing a plurality of options, such as 506-512. In one embodiment, said dropdown menu can appear on top of said program panel 504 while said calendar 505a is triggered.

FIG. 5C illustrates navigation system 505 with said wastewater application 513 having a plurality of submenu options. In one embodiment, hovering over said wastewater application 513 will expose said submenu options comprising a time on-off view 536, a GHAF view 537, a meter readings view 538 and an off-site wastewater view 539.

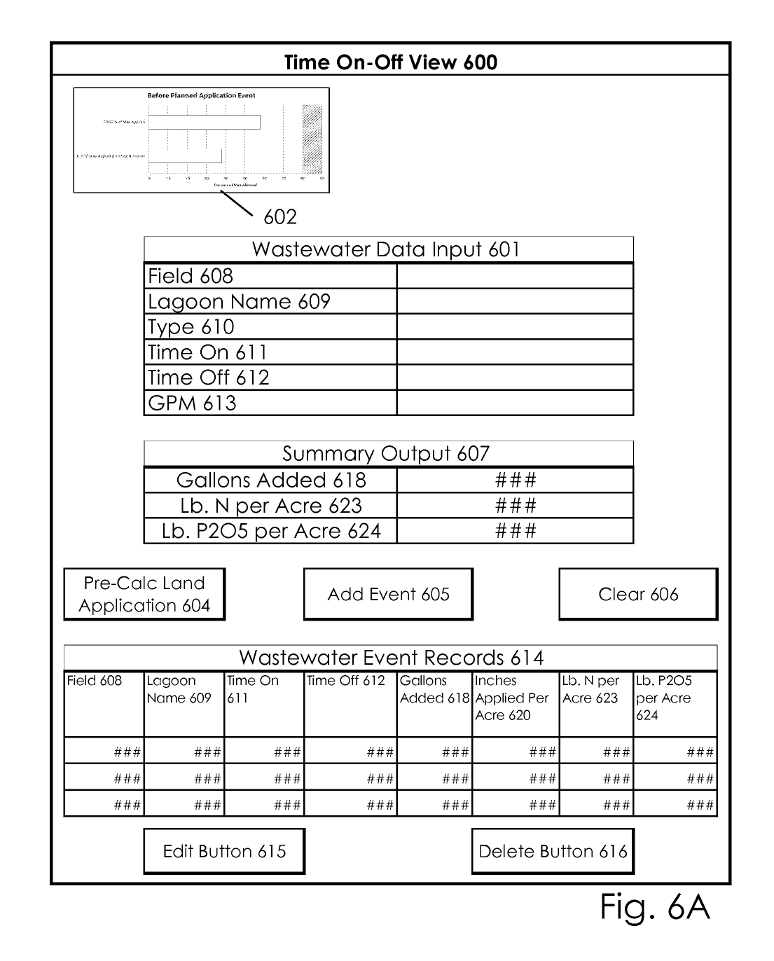

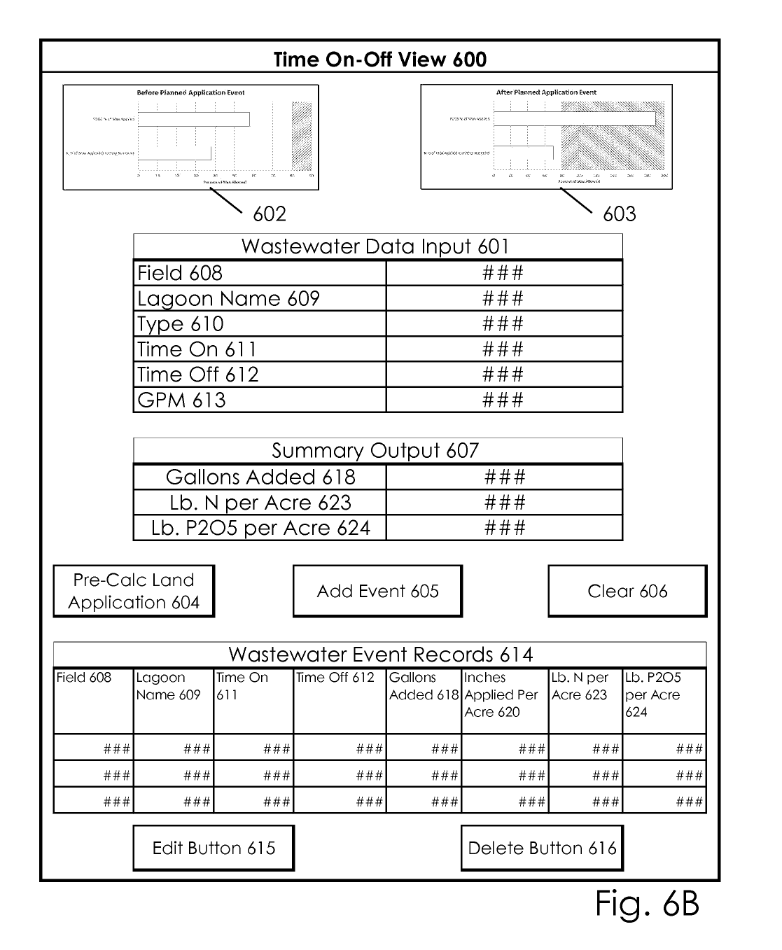

FIG. 6A illustrates a time on/off view 600. In one embodiment, clicking on time on-off view 536 can load time on/off view 600. In one embodiment, time on/off view 600 can display within said program panel 504. In one embodiment, time on/off view 600 can comprise one or more tools for managing and record keeping of wastewater.

Wastewater can comprise effluent, a liquid waste discharged from a sewage system. In one embodiment, said animal operations data management system 100 can track said wastewater in the context of CAFO.

Time on/off view 600 can comprise a wastewater data input 601, a before planned application event chart 602, an after planned application event chart 603 (illustrated below), a calculation button 604, an add event button 605, a clear button 606, and a summary output 607. In one embodiment, time on/off view 600 represents a portion of said device application 301. In one embodiment, wastewater data input 601 can collect user disposition data 309. In one embodiment, data entered into wastewater data input 601 can comprise animal operations data 203.

In one embodiment, wastewater data input 601 can comprise a field 608, a lagoon name 609, a type 610, a time on 611, a time off 612, and a GPM 613. In one embodiment, wastewater data input 601 can comprise data relating to a wastewater application event. In one embodiment, field 608 can comprise a location receiving wastewater in said wastewater application event, such as a plot of land, or similar. In one embodiment, type 610 can comprise a type, or categorization, of lagoon name 609. In one embodiment, time on 611 and time off 612 can comprise the beginning and ending time of said wastewater application event. In one embodiment, time on 611 and time off 612 can comprise a date and time data field. In one embodiment, GPM 613 can comprise a gallons-per-minute rate of said wastewater application event. In one embodiment, GPM 613 can be acquired by reading one or more meters attached to an irrigation system for field 608.

In one embodiment, time on/off view 600 can comprise one or more wastewater event records 614. Each of wastewater event records 614 can comprise one of said wastewater application events. Each field 608 can comprise one or more wastewater event records 614. In one embodiment, wastewater event records 614 on time on/off view 600 can comprise a table showing a summary of previous wastewater application events. In one embodiment, wastewater event records 614 can comprise an edit button 615 and a delete button 616. In one embodiment, one of wastewater event records 614 can be edited by selecting said one of wastewater event records 614 and then activating said edit button 615. Likewise, in one embodiment, one or more of said wastewater event records 614 can be deleted by being selected and activating delete button 616.

In one embodiment, wastewater data input 601 can be used to calculate wastewater event records 614. For example, in one embodiment, after one of said wastewater application events has occurred, data regarding said wastewater application event can be entered into wastewater data input 601 and added to wastewater event records 614 by clicking add event button 605. In one embodiment, when add event button 605 has been clicked upon, summary output 607 can calculate and display a summary of the recently entered regarding said wastewater application event. Further, in one embodiment, when add event button 605 is clicked upon, wastewater event records 614 can display records from said wastewater application event. In one embodiment, said animal operations data management system 100 can calculate a portion of summary output 607 and wastewater event records 614 when add event button 605 or calculation button 604 are clicked upon.

In one embodiment, a minutes-on 617 can comprise a number of minutes between time off 612 and time on 611. In one embodiment, a gallons added 618 can comprise the product of GPM 613 and minutes-on 617. In one embodiment, an acre-inches applied 619 can comprise gallons added 618 divided by 27,154 (which is a conversion rate from gallons to acre-inches). Referring to fields NMP data 405 and wastewater sample data 430 data specific to field 608 and lagoon name 609 can be calculated; wherein, field 608 equals field 406 and source 432 equals lagoon name 609. In one embodiment, an inches applied per acre 620 can comprise the product of acres WW 407 and acre-inches applied 619. In one embodiment, where source 432 equals lagoon name 609, a number N per acre-in 621 can comprise PAN 433 and a number P per acre-in 622 can comprise available P₂O₅ 434. In one embodiment, a pounds N per acre 623 can comprise the product of inches applied per acre 620 and number N per acre-in 621. In one embodiment, a pounds P₂O₅ per acre 624 can comprise the product of inches applied per acre 620 and number P per acre-in 622.

In one embodiment, summary output 607 can comprise gallons added 618, pounds N per acre 623 and pounds P₂O₅ per acre 624. In one embodiment, wastewater event records 614 can comprise field 608, lagoon name 609, time on 611, time off 612, gallons added 618, inches applied per acre 620, pounds N per acre 623 and pounds P₂O₅ per acre 624.

FIG. 6B illustrates time on/off view 600 with after planned application event chart 603. In one embodiment, said animal operations data management system 100 can calculate a projected wastewater application event. In one embodiment, after planned application event chart 603 can comprise a visual illustration of said projected wastewater application event created by entering a projected data into wastewater data input 601 and pressing calculation button 604. In one embodiment, by pressing calculation button 604 said animal operations data management system 100 can display after planned application event chart 603. In one embodiment, before planned application event chart 602 can comprise a summary of wastewater event records 614 before said projected wastewater application event and after planned application event chart 603 can comprise wastewater event records 614 with said projected wastewater application event. In one embodiment, summary output 607 can comprise calculations based upon said projected wastewater application event as entered into wastewater data input 601.

In one embodiment, before planned application event chart 602 can display a current P₂O₅ 625 and a current N 626 for one or more field 608. In one embodiment, current P₂O₅ 625 can comprise a sum of said pounds P₂O₅ per acre 624 calculated for each of field 608. Likewise, in one embodiment, current N 626 can comprise a sum of said pounds N per acre 623 for each of field 608. In one embodiment, after planned application event chart 603 can display a projected P₂O₅ 627 and a projected N 628. In one embodiment, projected P₂O₅ 627 can comprise a sum of pounds P₂O₅ per acre 624 for both wastewater event records 614 and said projected wastewater application event. Likewise, in one embodiment, projected N 628 can comprise pounds N per acre 623 for both wastewater event records 614 and said projected wastewater application event.

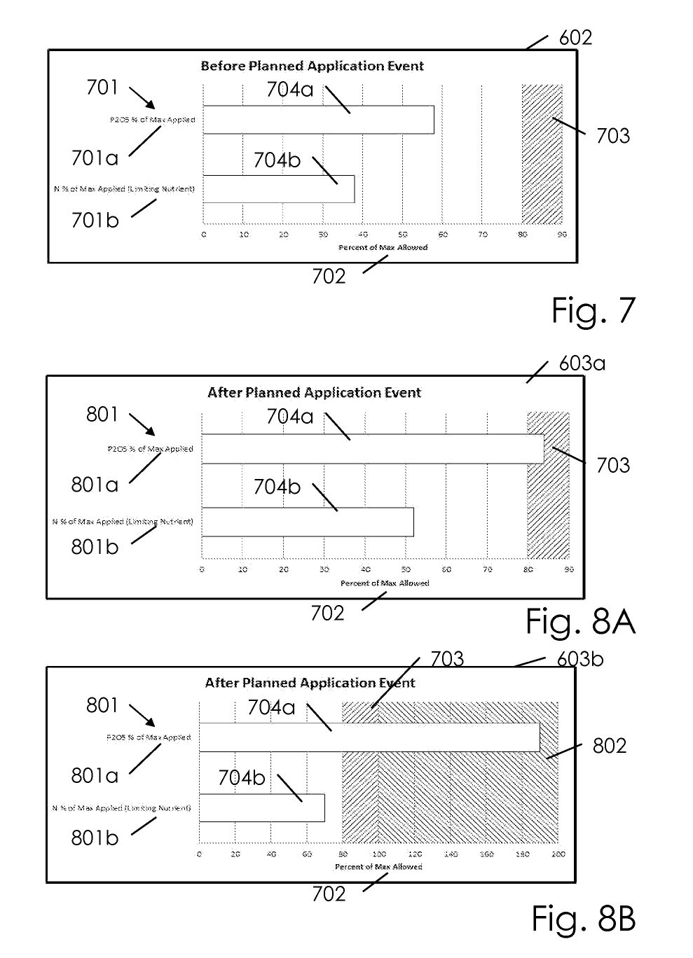

FIG. 7 illustrates said before planned application event chart 602. In one embodiment, before planned application event chart 602 can comprise a bar chart. In one embodiment, before planned application event chart 602 can comprise one or more current percent of maximum nutrient 701 plotted along a percent of max allowed 702. In one embodiment, said percent of max allowed 702 can comprise a warning zone 703. In one embodiment, warning zone 703 can comprise 80%-100% of percent of percent of max allowed 702. Current percent of maximum nutrient 701 can comprise a current P₂O₅ percent 701a and a current N percent 701b. In one embodiment, current P₂O₅ percent 701a can comprise said current P₂O₅ 625 divided by said max P 410 of said fields NMP data 405; wherein, field 406 equals field 608. Likewise, current N percent 701b can comprise said current N 626 divided by max N 409.

In one embodiment, before planned application event chart 602 can comprise a bar chart. In one embodiment, where one of current P₂O₅ percent 701a or current N percent 701b are within warning zone 703, a user can be advised to be careful when applying more of either current percent of maximum nutrient 701. In one embodiment, warning zone 703 can comprise a distinct color or pattern along percent of max allowed 702, as illustrated in FIG. 7. In one embodiment, current P₂O₅ percent 701a and current N percent 701b can each be represented on before planned application event chart 602 as one or more bars 704. For example, in one embodiment, bars 704 can comprise a first bar 704a for current P₂O₅ percent 701a and a second bar 704b for current N percent 701b. In one embodiment, before planned application event chart 602 can comprise data for one or a plurality of field 608 by illustrating one or more sets of bars 704 per current P₂O₅ percent 701a and current N percent 701b.

FIGS. 8A and 8B illustrate two views of after planned application event chart 603. After planned application event chart 603 can comprise an after planned application event chart 603a and an after planned application event chart 603b. In one embodiment, after planned application event chart 603 can comprise before planned application event chart 602 further comprising said projected wastewater application event (as discussed supra). In one embodiment, after planned application event chart 603 can comprise one or more projected percent of maximum nutrient 801. In one embodiment, projected percent of maximum nutrient 801 can comprise a projected P₂O₅ percent 801a and a projected N percent 801b.

In one embodiment, projected P₂O₅ percent 801a can comprise a sum of current P₂O₅ 625 and projected P₂O₅ 627 divided by max P 410 of fields NMP data 405; i.e.,

$$projected P 2 O 5 percent 801 a = \frac{[ current P 2 O 5 \; 625 ] + [ projected P 2 O 5 \; 627 ]}{[ max P 410 ]} .$$

Likewise, in one embodiment, projected N percent 801b can comprise a sum of current N 626 and projected N 628 divided by max N 409 of fields NMP data 405; i.e.,

$$projected N percent 801 b = \frac{[ current N 626 [ + [ projected N 628 ]}{[ max N 409 ]} .$$

In one embodiment, after planned application event chart 603 can comprise a bar chart comprising projected percent of maximum nutrient 801 over percent of max allowed 702. In one embodiment, after planned application event chart 603 can comprise warning zone 703 and a violation zone 802. In one embodiment, violation zone 802 can comprise a portion of percent of max allowed 702 above an allowable range of nutrients allowed. In one embodiment, percent of max allowed 702 can comprise a scale from 0-100%; wherein, 100% represents a maximum projected percent of maximum nutrient 801 allowed; further wherein, any value above 100% can comprise violation zone 802. In one embodiment, violation zone 802 and warning zone 703 can comprise distinct patterns or colors from one another.

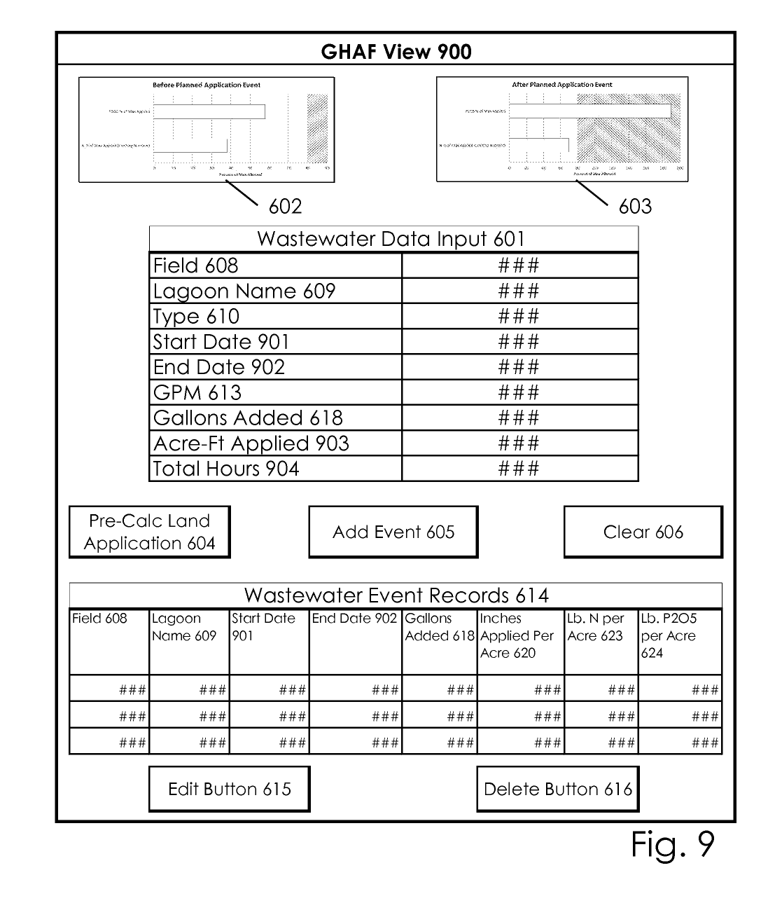

FIG. 9 illustrates a GHAF view 900 of wastewater application 513. “GHAF” can comprise an abbreviation of Gallons, Hours, and/or Acre-Feet. In one embodiment, GHAF view 900 can comprise a similar view to time on/off view 600 but comprise different calculation methods. For example, in one embodiment, wastewater data input 601 for GHAF view 900 can comprise field 608, lagoon name 609, type 610, a start date 901, an end date 902, GPM 613, gallons added 618, an acre-feet applied 903 and a total hours 904. Said start date 901 and end date 902 can comprise record keeping functions of said animal operations data management system 100; wherein, said start date 901 and end date 902 can comprise a starting date and an ending date of a recording period of said wastewater application events. In one embodiment, one or more of wastewater data input 601 in GHAF view 900 can comprise meter readings collected from an irrigation system measuring said wastewater application events, including GPM 613, gallons added 618, acre-feet applied 903 and total hours 904.

Said animal operations data management system 100 can calculate said acre-inches applied 619 by three means under GHAF view 900 to arrive at wastewater event records 614; viz., (i) a gallons method, (ii) an hours method, and (iii) an acre-ft method. In all cases, once acre-inches applied 619 is calculated, inches applied per acre 620, pounds N per acre 623 and pounds P₂O₅ per acre 624 can be calculated (as discussed supra under FIGS. 6A and 6B). In said gallons method, acre-inches applied 619 can comprise gallons added 618 divided by 27,154. In said hours method, minutes-on 617 can comprise a product of said total hours 904 and sixty (60); gallons added 618 can comprise a product of minutes-on 617 and GPM 613; and acre-inches applied 619 can comprise gallons added 618 divided by 27,154. In said acre-ft method, acre-inches applied 619 can comprise a product of acre-feet applied 903 and twelve (12). Thus, inches applied per acre 620, pounds N per acre 623 and pounds P₂O₅ per acre 624 can be calculated from acre-inches applied 619 as discussed supra.

Wastewater event records 614 on GHAF view 900 can comprise field 608, lagoon name 609, said start date 901, end date 902, gallons added 618, inches applied per acre 620, pounds N per acre 623, and pounds P₂O₅ per acre 624.

GHAF view 900 can comprise many of the same functions as time on/off view 600, such as wastewater data input 601, before planned application event chart 602, after planned application event chart 603, calculation button 604, add event button 605, clear button 606, wastewater event records 614, edit button 615 and delete button 616.

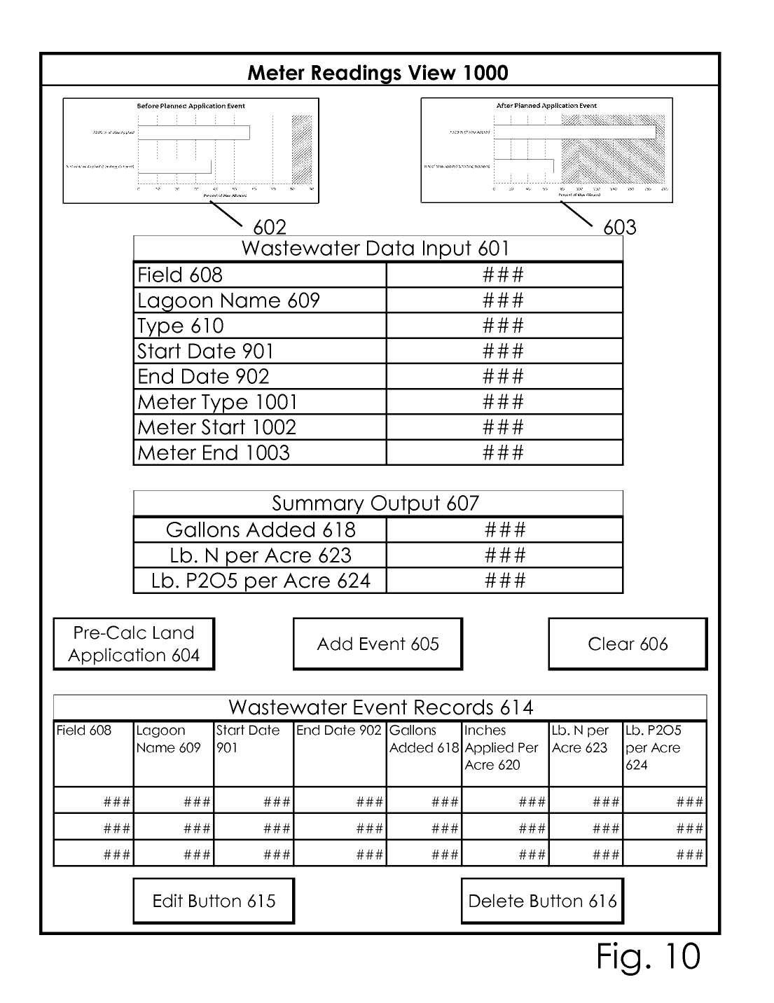

FIG. 10 illustrates a meter readings view 1000 of wastewater application 513. In one embodiment, meter readings view 1000 can comprise a similar view to time on/off view 600 and/or GHAF view 900 but may comprise different calculation methods. Meter readings view 1000 can comprise wastewater data input 601 before planned application event chart 602, after planned application event chart 603, calculation button 604, add event button 605, clear button 606, summary output 607, wastewater event records 614, edit button 615 and delete button 616. In one embodiment, wastewater data input 601 for meter readings view 1000 can comprise field 608, lagoon name 609, type 610, time on 611, time off 612, meter type 1001, meter start 1002, and meter end 1003. In one embodiment, meter type 1001 can comprise one of gallons, gallons X100, gallons X1000, acre-inches, or acre-feet (each comprising a unit of volume). Said units of volume of meter type 1001 can each be converted to gallons. Meter start 1002 and meter end 1003 can comprise a reading of a meter before and after said wastewater application event. Thus, in one embodiment, gallons added 618 can comprise a difference between meter end 1003 and meter start 1002. Accordingly, with gallons added 618 values in summary output 607 and wastewater event records 614 can be calculated as discussed supra.

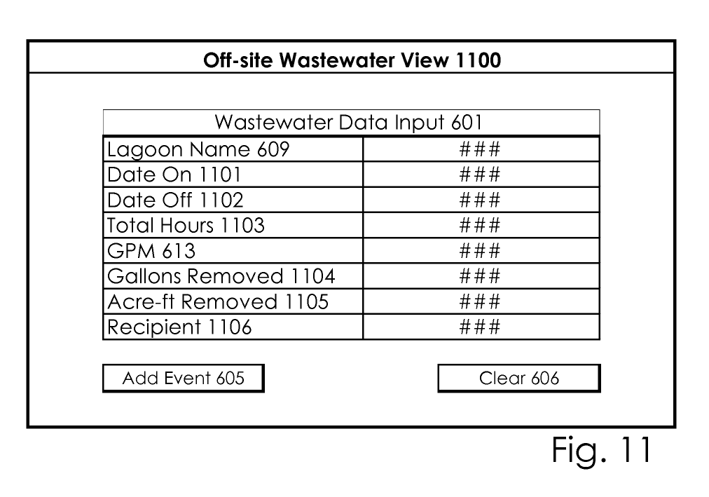

FIG. 11 illustrates an off-site wastewater view 1100 of wastewater application 513. In one embodiment, off-site wastewater view 1100 can be used to collect wastewater data input 601 relevant to an off-site wastewater application event. In one embodiment, a permit may be required before removing said wastewater. In one embodiment, said wastewater can be removed by a pipe and can be measured at an entry point of said pipe. In one embodiment, wastewater data input 601 for off-site wastewater view 1100 can comprise lagoon name 609, a date on 1101, a date off 1102, a total hours 1103, GPM 613, a gallons removed 1104, an acre-ft removed 1105, and a recipient 1106. In one embodiment, date on 1101 and date off 1102 can comprise a beginning and ending date of said off-site wastewater application event. In one embodiment, total hours 1103 and GPM 613 can be tracked and read on a meter attached to said pipe. In one embodiment, gallons removed 1104 can comprise a product of total hours 1103 and GPM 613. In one embodiment, gallons removed 1104 can be tracked by said meter. In one embodiment, gallons removed 1104 can be converted to another volume such as acre-feet and recorded into acre-ft removed 1105. In one embodiment, acre-ft removed 1105 can comprise gallons removed 1104 divided by 325,853. In one embodiment, said recipient 1106 can comprise one of said lagoon name 609 or said field 608 owned and operated off-site or on-site. Accordingly, if wastewater is transferred between a plurality of said lagoon name 609 on the same site, then debiting said wastewater from a first among said lagoon name 609 may require crediting said wastewater to a second among said lagoon name 609 (that is, said recipient 1106).

In one embodiment, all of time on/off view 600, GHAF view 900, meter readings view 1000 and off-site wastewater view 1100 can comprise a means of planning for wastewater management. In one embodiment, said animal operations data management system 100 can be used for wastewater planning up to 6 months in advance.

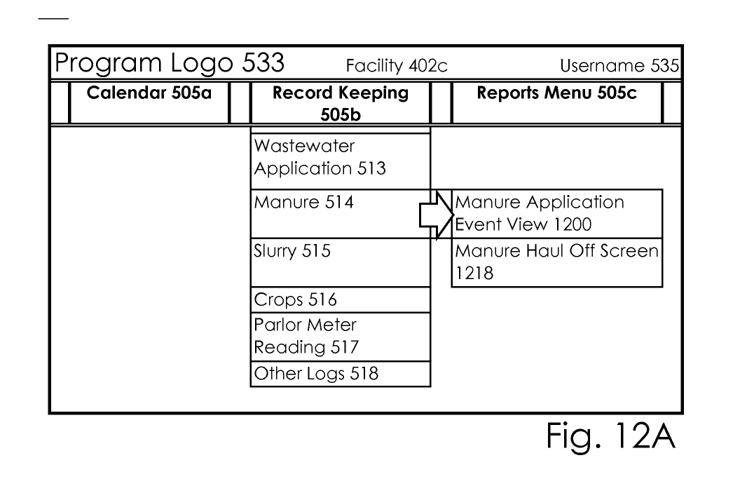

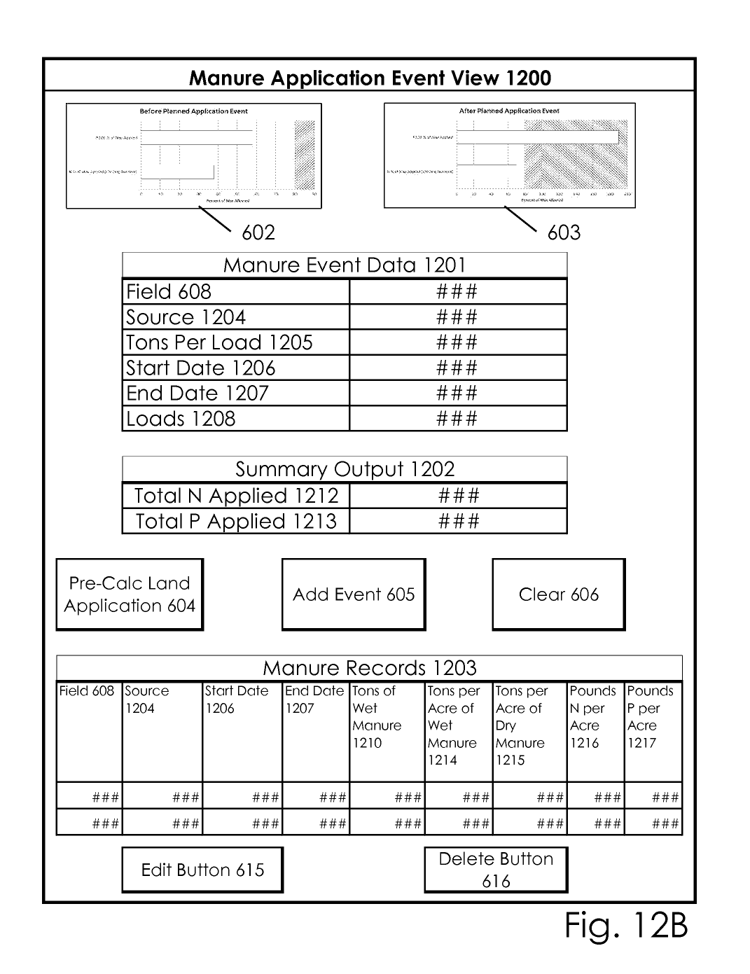

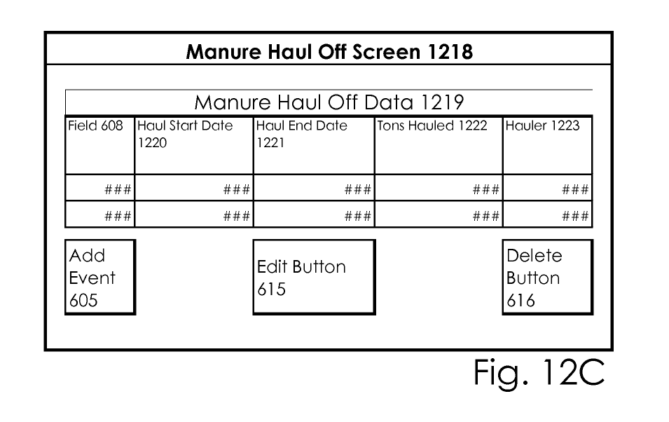

FIG. 12A illustrates navigation system 505 with manure 514 comprising a plurality of submenu options. In one embodiment, manure 514 can comprise a manure application event view 1200 and a manure haul-off screen 1218, as discussed infra.

FIG. 12B illustrates manure application event view 1200. In one embodiment, manure application event view 1200 can be loaded when manure 514 is clicked from within navigation system 505. In one embodiment, manure application event view 1200 can comprise before planned application event chart 602, after planned application event chart 603, calculation button 604, add event button 605, clear button 606, one or more manure event data 1201, one or more summary output 1202, and one or more manure records 1203. In one embodiment, manure event data 1201 can comprise data related to the addition or removal of animal manure from field 608. In one embodiment, manure event data 1201 can comprise field 608, a source 1204, a tons per load 1205, a start date 1206, an end date 1207 and a loads 1208. In one embodiment, a user can input information into manure event data 1201 and click either calculation button 604 to predict the effect of a predicted manure event or add event button 605 to record an actual manure event. In one embodiment, clicking said calculation button 604 or add event button 605 can cause before planned application event chart 602 and after planned application event chart 603 to refresh, as is described supra. In one embodiment, source 1204 can comprise data related to the origin of said manure. In one embodiment, tons per load 1205 can comprise a number of tons per load added to field 608. In one embodiment, start date 1206 and end date 1207 can comprise time data relevant to a manure event. In one embodiment, end date 1207 can be equal to start date 1206 where a land application event has been begun but not finished.

In one embodiment, a tons applied 1209 can comprise a product of tons per load 1205 and loads 1208. In one embodiment, a tons of wet manure 1210 can comprise tons applied 1209. In one embodiment, a tons of dry manure 1211 can comprise tons of wet manure 1210 divided by percent moisture 439 (of said manure sample data 436).

In one embodiment, summary output 1202 can comprise a total N applied 1212 and a total P applied 1213. In one embodiment, total N applied 1212 can comprise a product of tons of dry manure 1211, PAN 440 and two-thousand (2,000). In one embodiment, total P applied 1213 can comprise a product of tons of dry manure 1211, available P₂O₅ 441, and two-thousand (2,000).

In one embodiment, manure records 1203 can comprise a portion of manure event data 1201, one or more calculated values, and a portion of event records 305. In one embodiment, manure records 1203 can comprise field 608, source 1204, start date 1206, end date 1207, tons of wet manure 1210, a tons per acre of wet manure 1214, a tons per acre of dry manure 1215, a pounds N per acre 1216, and a pounds P per acre 1217. In one embodiment, tons per acre of wet manure 1214 can comprise tons of wet manure 1210 divided by acres manure 408. In one embodiment, tons per acre of dry manure 1215 can comprise tons of dry manure 1211 divided by acres manure 408. In one embodiment, pounds N per acre 1216 can comprise total N applied 1212 divided by acres manure 408. In one embodiment, pounds P per acre 1217 can comprise total P applied 1213 divided by acres manure 408.

FIG. 12C illustrates manure haul-off screen 1218. In one embodiment, manure 514 is activated to expose a link to manure haul-off screen 1218, which can be selected to open manure haul-off screen 1218. In one embodiment, manure haul-off screen 1218 can comprise a display of one or more manure haul-off data 1219. In one embodiment, manure haul-off data 1219 can be added and edited within manure haul-off screen 1218. In one embodiment, manure haul-off data 1219 can comprise field 608, a haul start date 1220, a haul end date 1221, a tons hauled 1222 and a hauler 1223. In one embodiment, haul start date 1220 and haul end date 1221 can comprise a beginning and end of a manure haul-off event. In one embodiment, tons hauled 1222 can comprise an amount of manure removed during said manure haul-off event. In one embodiment, hauler 1223 can comprise an identifier for a hauler engaged in said manure haul-off event. In one embodiment, manure records 1203 can be edited by clicking on an edit button 615. In one embodiment, manure records 1203 can be added by inserting data into manure haul-off data 1219 and clicking on add event button 605, as is well known in the art. In one embodiment, one of manure haul-off data 1219 can be deleted by selecting one of manure haul-off data 1219, and clicking said delete button 616.

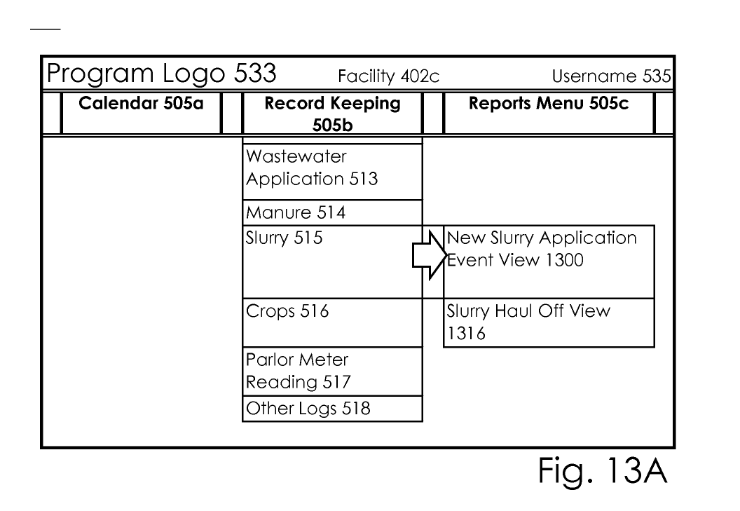

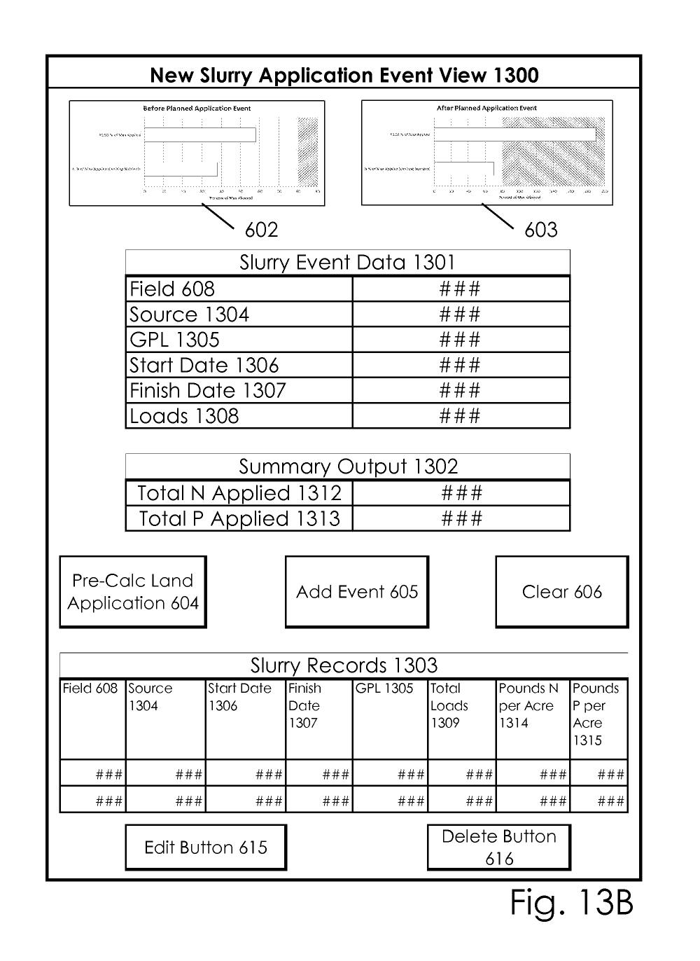

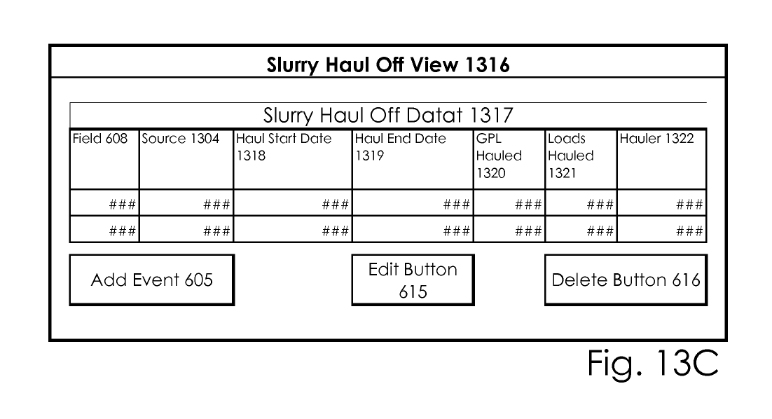

FIG. 13A illustrates navigation system 505 with slurry 515 comprising a plurality of submenu options. In one embodiment, slurry 515 can comprise a new slurry application event screen 1300 and a slurry haul-off screen 1316, as discussed infra.

FIG. 13B illustrates new slurry application event screen 1300. In one embodiment, new slurry application event screen 1300 can be loaded when slurry 515 is clicked from within navigation system 505. In one embodiment, new slurry application event screen 1300 can comprise before planned application event chart 602, after planned application event chart 603, calculation button 604, add event button 605, clear button 606, one or more slurry event data 1301, one or more summary output 1302 and one or more slurry records 1303. In one embodiment, slurry event data 1301 can comprise data related to the addition or removal of animal slurry from field 608. In one embodiment, slurry event data 1301 can comprise field 608, a source 1304, a GPL 1305, a start date 1306, a finish date 1307 and one or more loads 1308. In one embodiment, a user can input information into slurry event data 1301 and click said calculation button 604 to predict the effect of a predicted slurry event or add event button 605 to record a slurry event. In one embodiment, clicking said calculation button 604 or add event button 605 can cause before planned application event chart 602 and after planned application event chart 603 to refresh, as is described supra. In one embodiment, source 1304 can comprise data related to the origin of said slurry. In one embodiment, GPL 1305 can comprise a number of gallons per load added to field 608. In one embodiment, start date 1306 and finish date 1307 can comprise time data relevant to a slurry event. In one embodiment, finish date 1307 can be equal to start date 1306 where a land application event has been begun but not finished.

In one embodiment, a total loads 1309 can comprise a sum of all loads 1308 for a field 608. In one embodiment, a total gallons 1310 can comprise a product of total loads 1309 and GPL 1305. In one embodiment, a manure applied 1311 can comprise one thousand (1,000) times said total gallons 1310 divided by said density 447. Having calculated said manure applied 1311, a total N applied 1312 and a total P applied 1313 can be calculated. In one embodiment, total N applied 1312 can comprise manure applied 1311 divided by PAN 450. In one embodiment, total P applied 1313 can comprise manure applied 1311 divided by available P₂O₅ 451. In one embodiment, summary output 1302 can comprise total N applied 1312 and total P applied 1313.

In one embodiment, slurry records 1303 can comprise all slurry events relevant to a field or set of fields. In one embodiment, slurry records 1303 can comprise a portion of event records 305. In one embodiment, slurry records 1303 can comprise field 608, source 1304, start date 1306, finish date 1307, GPL 1305, total loads 1309, a pounds N per acre 1314, and a pounds P per acre 1315. In one embodiment, pounds N per acre 1314 can comprise total N applied 1312 divided by acres manure 408. In one embodiment, pounds P per acre 1315 can comprise total P applied 1313 divided by acres manure 408.

FIG. 13C illustrates a slurry haul-off screen 1316. In another embodiment, slurry haul-off screen 1316 can be displayed when a user clicks on slurry 515 within navigation system 505. In one embodiment, slurry haul-off screen 1316 can comprise a display of one or more slurry haul-off events comprising one or more slurry haul-off data 1317. In one embodiment, slurry haul-off data 1317 can be added and edited within slurry haul-off screen 1316. In one embodiment, slurry haul-off data 1317 can comprise field 608, source 1304, a haul start date 1318, a haul end date 1319, a GPL hauled 1320, a loads hauled 1321 and a hauler 1322. In one embodiment, hauler 1322 can comprise a name or company name of a party removing slurry from one of field 608. In one embodiment, slurry haul-off data 1317 can be edited by clicking on said edit button 615. In one embodiment, said slurry haul-off data 1317 can be added by clicking on said add event button 605 and adding slurry haul-off data 1317 as is well known in the art. In one embodiment, haul start date 1318 and haul end date 1319 can comprise a start and end date for a haul off event. In one embodiment, said GPL hauled 1320 can comprise a meter reading or capacity of a hauling vehicle. In one embodiment, said loads hauled 1321 can comprise a quantity of loads of slurry hauled by hauler 1322.

In one embodiment, said animal operations data management system 100 can comprise: receiving a data regarding a projected application event (such as said wastewater data input 601, said manure event data 1201 and/or said slurry event data 1301), generating said after planned application event chart 603 before said projected application event has taken place, and displaying said after planned application event chart 603 along with said before planned application event chart 602. Thus, in one embodiment said animal operations data management system 100 can assist with planning and environmental protection.

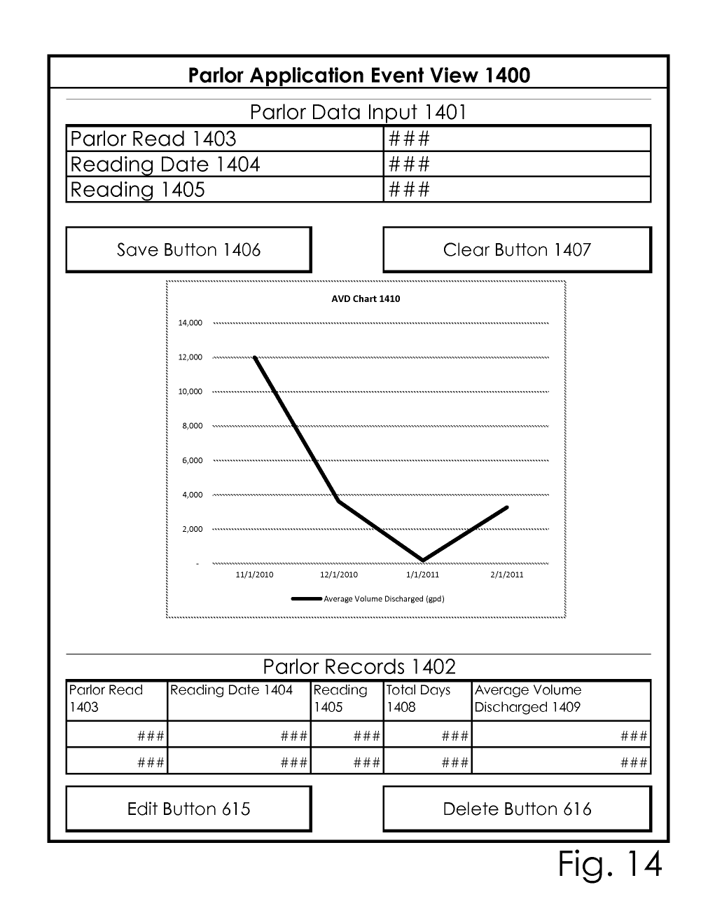

FIG. 14 illustrates a parlor meter readings screen 1400. In one embodiment, said device application 301 can display said parlor meter readings screen 1400 when a user clicks on parlor meter reading 517. In one embodiment, parlor meter readings screen 1400 can be used to record parlor meter readings. In one embodiment, parlor can comprise water runoff used to clean facilities carrying nutrient enriched manure, slurry, or similar. Parlor meter readings screen 1400 can comprise a parlor data input 1401 and a parlor records 1402. In one embodiment, parlor data input 1401 can comprise a parlor read 1403, a reading date 1404 and a reading 1405. In one embodiment, parlor data input 1401 can be entered into parlor data input 1401 and saved by clicking a save button 1406. In one embodiment, data entered into parlor data input 1401 can be deleted by clicking a clear button 1407. In one embodiment, parlor read 1403 can comprise a unique identifier related to a particular parlor reading. In one embodiment, reading date 1404 can comprise a date of a parlor reading. In one embodiment, reading 1405 can comprise a meter reading. In one embodiment, parlor records 1402 can comprise

Parlor records 1402 can comprise parlor read 1403, reading date 1404, reading 1405, a total days 1408 and an average volume discharged 1409. In one embodiment, said total days 1408 can be calculated as a number of days between a current date (likely the date entered into said reading date 1404 of said parlor data input 1401) and a most recent date for said parlor read 1403 stored in said parlor records 1402. In one embodiment, said average volume discharged 1409 can be calculated as a difference between said reading 1405 in said parlor data input 1401 and said reading 1405 in said registration data 402 divided by said total days 1408. In one embodiment, said average volume discharged 1409 can comprise an estimate of a volume of parlor discharged per day for a period between a two of said reading dates 1404.

In one embodiment, total days 1408 can be populated automatically by taking the difference of a current of said total days 1408 a most recent among total days 1408 for one of said field 608. In one embodiment, said average volume discharged 1409 can comprise the average volume discharged (“AVD”) in gallons per day (“GPD”). In one embodiment, average volume discharged 1409 can comprise an average gallons per day since said most recent among said total days 1408.

In one embodiment, parlor records 1402 can comprise a portion of event records 305. In one embodiment, parlor records 1402 can comprise parlor records 1402 for field 608 over the course of many data entries. In one embodiment, parlor records 1402 can be graphically shown on parlor meter readings screen 1400 as an AVD chart 1410. In one embodiment, AVD chart 1410 can comprise average volume discharged 1409 charted over the course of many parlor reading events.

In one embodiment, when a user clicks on parlor 522 within navigation system 505, said device application 301 can present a portion of parlor meter readings screen 1400.

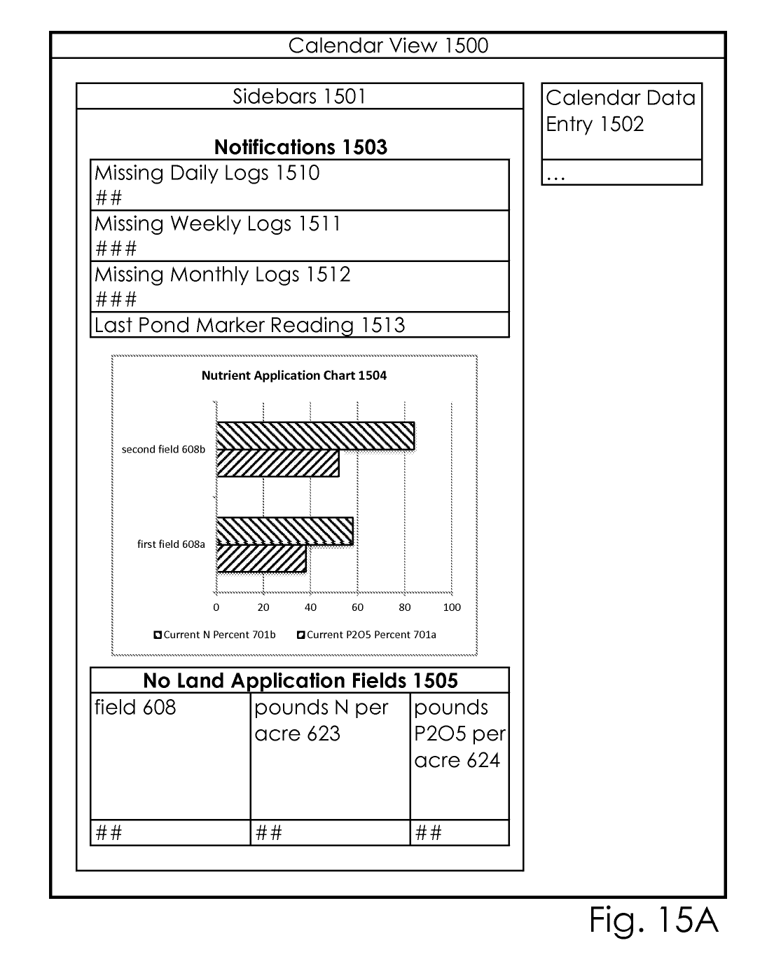

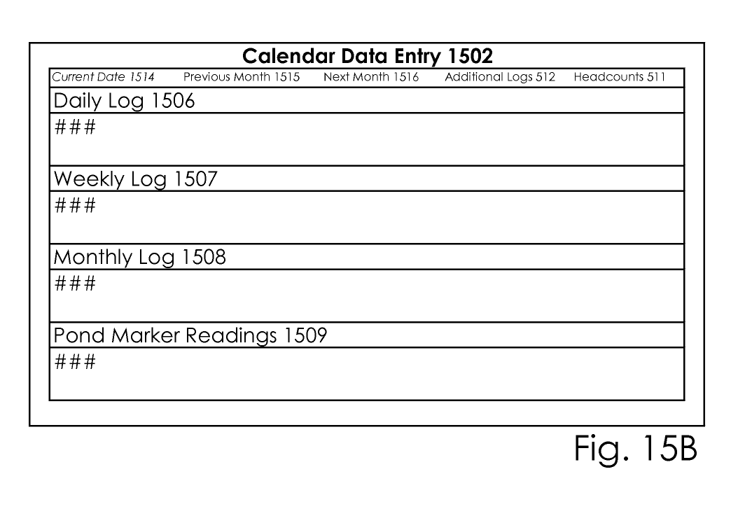

FIGS. 15A and 15B illustrate two views of a calendar view 1500. In one embodiment, calendar view 1500 can comprise one or one or more sidebars 1501 and a calendar data entry 1502. In one embodiment, calendar view 1500 can display within said program panel 504. In one embodiment, sidebars 1501 and calendar data entry 1502 can display alongside one another.

FIG. 15A illustrates a portion of calendar data entry 1502 and one embodiment of sidebars 1501. Sidebars 1501 can comprise a notifications 1503, a nutrient application chart 1504 and a no land application fields 1505.

FIG. 15B illustrates a portion of calendar data entry 1502. In one embodiment, calendar data entry 1502 can comprise a daily log 1506, a weekly log 1507, a monthly log 1508, and a pond marker readings 1509.

In one embodiment, notifications 1503 can comprise a missing daily logs 1510, a missing weekly logs 1511, a missing monthly logs 1512 and a last pond marker reading 1513. In one embodiment, notifications 1503 can comprise a display used to alert users of said animal operations data management system 100 that certain logs have not been provided. For example, in one embodiment, 1510-1513 can illustrate missing logs as their name implies. Daily logs, weekly logs, monthly logs, and pond marker readings are discussed infra. In one embodiment, a user can click on links within notifications 1503 to access a form to enter missing logs.

In one embodiment, nutrient application chart 1504 can comprise a bar chart comprising a current nutrient status of one or more fields 608. Field 608 can comprise a first field 608a and a second field 608b each comprising said current nutrient status. In one embodiment, said current nutrient status can comprise said current P₂O₅ percent 701a and said current N percent 701b for each among said fields 608. In one embodiment, nutrient application chart 1504 can comprise said warning zone 703 (not illustrated here) and said violation zone 802 (not illustrated here).

In one embodiment, no land application fields 1505 can comprise data related to one or more field 608. In one embodiment, no land application fields 1505 can comprise fields 608 within said warning zone 703 and/or violation zone 802. In one embodiment, no land application fields 1505 can comprise fields 608 with said current P₂O₅ percent 701a and/or said current N percent 701b above a threshold set by users of said animal operations data management system 100.

In one embodiment, calendar data entry 1502 can comprise one or one or more logs tied to a daily, weekly, monthly or meter reading frequency, as discussed infra. In one embodiment, calendar data entry 1502 can comprise one or one or more navigation controls such as a current date 1514, a previous month 1515, a next month 1516, additional logs 512 and headcounts 511. In one embodiment, current date 1514 can comprise a static text displaying a current date. In one embodiment, previous month 1515 and next month 1516 can comprise links to previous and future months for calendar data entry 1502. In one embodiment, additional logs 512 and headcounts 511 can open views to be discussed infra.

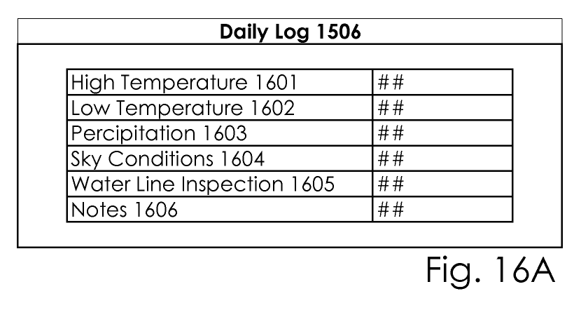

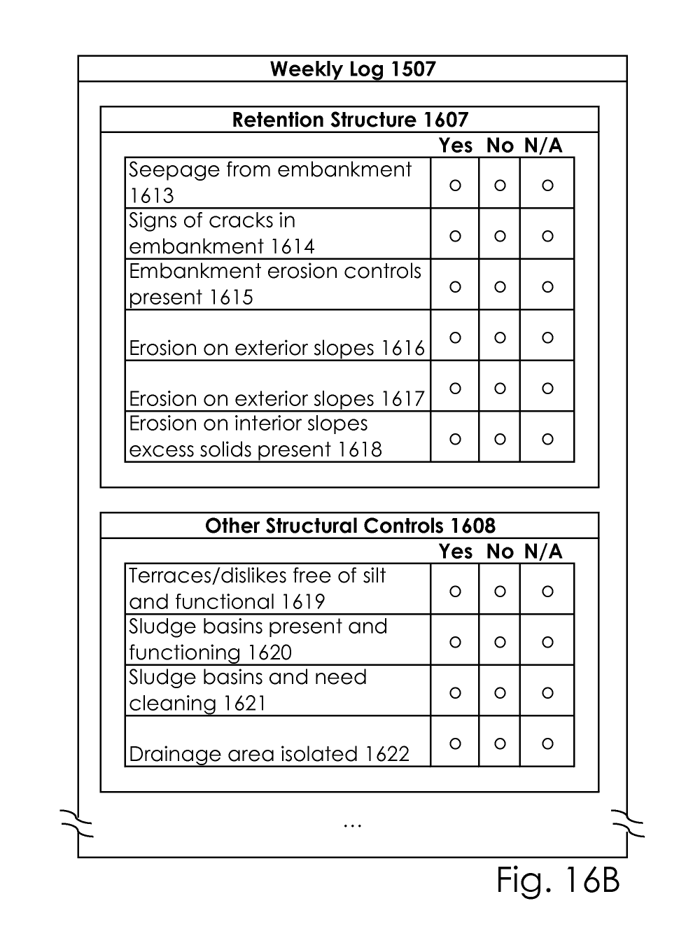

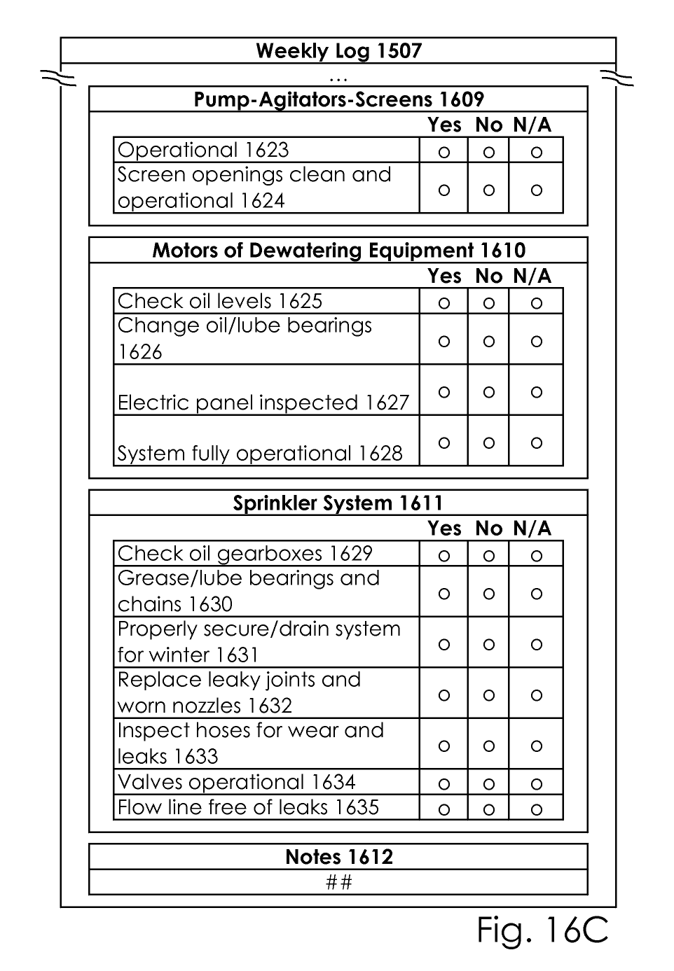

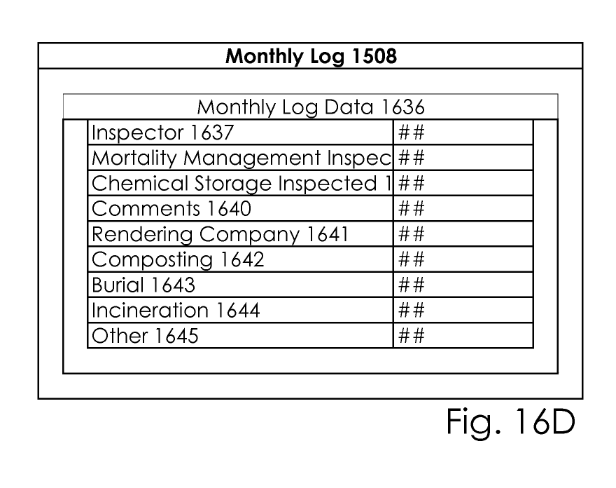

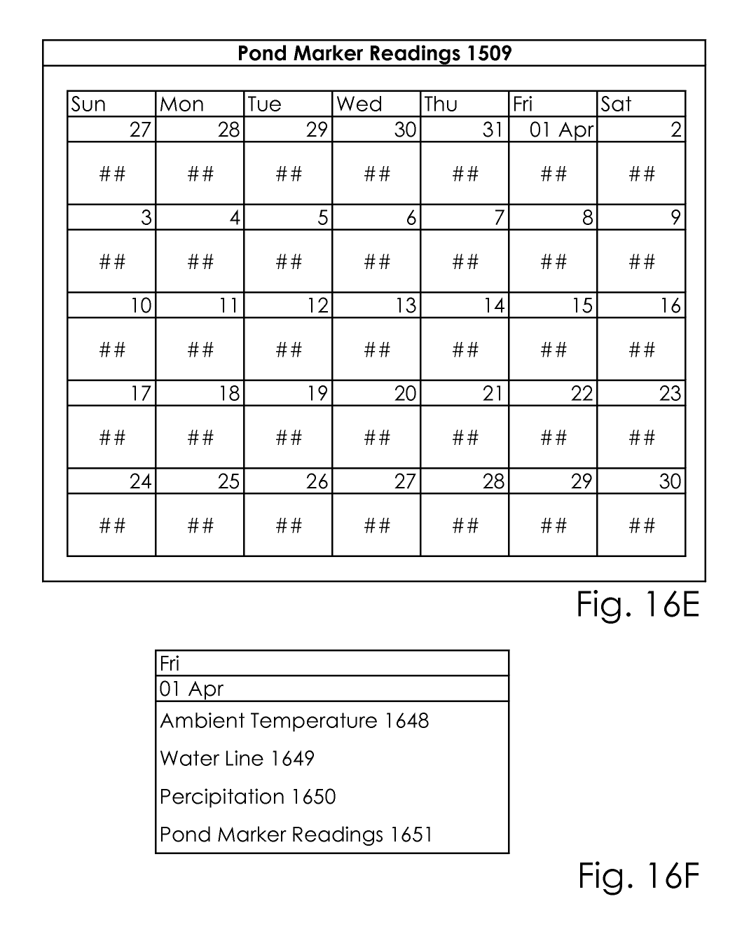

FIG. 16A illustrates daily log 1506. Daily log 1506 can comprise a high temperature 1601, a low temperature 1602, a precipitation 1603, a sky conditions 1604, a water line inspection 1605, and a notes 1606. In one embodiment, high temperature 1601 and low temperature 1602 can comprise a temperature range at a location. In one embodiment, precipitation 1603 and sky conditions 1604 can comprise a climate condition record at a location. In one embodiment, water line inspection 1605 can comprise a yes/no flag comprising a record of whether a water line was inspected on a date. In one embodiment, all data in daily log 1506 can each correspond to a date and location. In one embodiment, notes 1606 can comprise an open text field for collecting data, such as facility conditions, rain record, water line, or similar.

FIGS. 16B and 16C illustrate a top portion and lower portion of said weekly log 1507. In one embodiment, weekly log 1507 can comprise a retention structure 1607, an other structural controls 1608, a pump-agitators-screens 1609, a motors of dewatering equipment 1610, a sprinkler system 1611 and a motors of dewatering equipment 1610. In one embodiment, weekly log 1507 can comprise a plurality of fields in a checklist having a yes, no, or not-applicable answer to each list item. For example, in one embodiment, fields numbering 1613-1635 can comprise items having three radio button options (yes, no, N/A). In one embodiment, retention structure 1607 can comprise a seepage from embankment 1613, a signs of cracks in embankment 1614, an embankment erosion controls present 1615, an erosion on exterior slopes 1616, an erosion on exterior slopes 1617, and an erosion on interior slopes excess solids present 1618. In one embodiment, other structural controls 1608 can comprise a terraces/dislikes free of silt and functional 1619, a sludge basins present and functioning 1620, a sludge basins and need cleaning 1621, and a drainage area isolated 1622. In one embodiment, pump-agitators-screens 1609 can comprise an operational 1623 and a screen openings clean and operational 1624. In one embodiment, motors of dewatering equipment 1610 can comprise a check oil levels 1625, a change oil/lube bearings 1626, an electric panel inspected 1627 and a system fully operational 1628. In one embodiment, sprinkler system 1611 can comprise a check oil gearboxes 1629, a grease/lube bearings and chains 1630, a properly secure/drain system for winter 1631, a replace leaky joints and worn nozzles 1632, an inspect hoses for wear and leaks 1633, a valves operational 1634, and a flow line free of leaks 1635. In one embodiment, notes 1612 can comprise an open text field for collecting data within weekly log 1507. In one embodiment, weekly log 1507 can comprise a button for submitting, editing, and clearing data entered. In one embodiment, items 1613-1635 can comprise checklist items well known in the art and corresponding to their titles supra.

FIG. 16D illustrates monthly log 1508. In one embodiment, monthly log 1508 can comprise one or more monthly log data 1636. In one embodiment, monthly log data 1636 can comprise a inspector 1637, a mortality management inspected 1638, a chemical storage inspected 1639, a comments 1640, a rendering company 1641, a composting 1642, a burial 1643, incineration 1644, and an other 1645. In one embodiment, items 1637-1645 can comprise checklist items well known in the art and corresponding to their titles supra.

FIGS. 16E and 16F illustrate an overview and detailed view of pond marker readings 1509. In one embodiment, pond marker readings 1509 can comprise a monthly calendar display comprising space under each day on said monthly calendar display to hold data relevant to that day. For example, in one embodiment, each day can comprise an ambient temperature 1648, a water line 1649, a precipitation 1650 and a pond marker readings 1651.

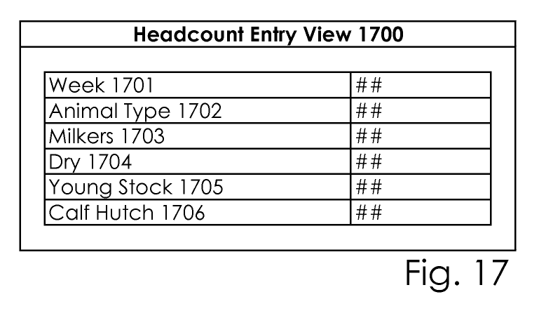

FIG. 17 illustrates a headcount entry view 1700. In one embodiment, headcount entry view 1700 can comprise a week 1701, an animal type 1702, a milkers 1703, a dry 1704, a young stock 1705, and a calf hutch 1706. In one embodiment, headcount entry view 1700 can comprise a log of a number different animal types in each week 1701. In one embodiment, 1702-1706 can comprise a range of different animal types.

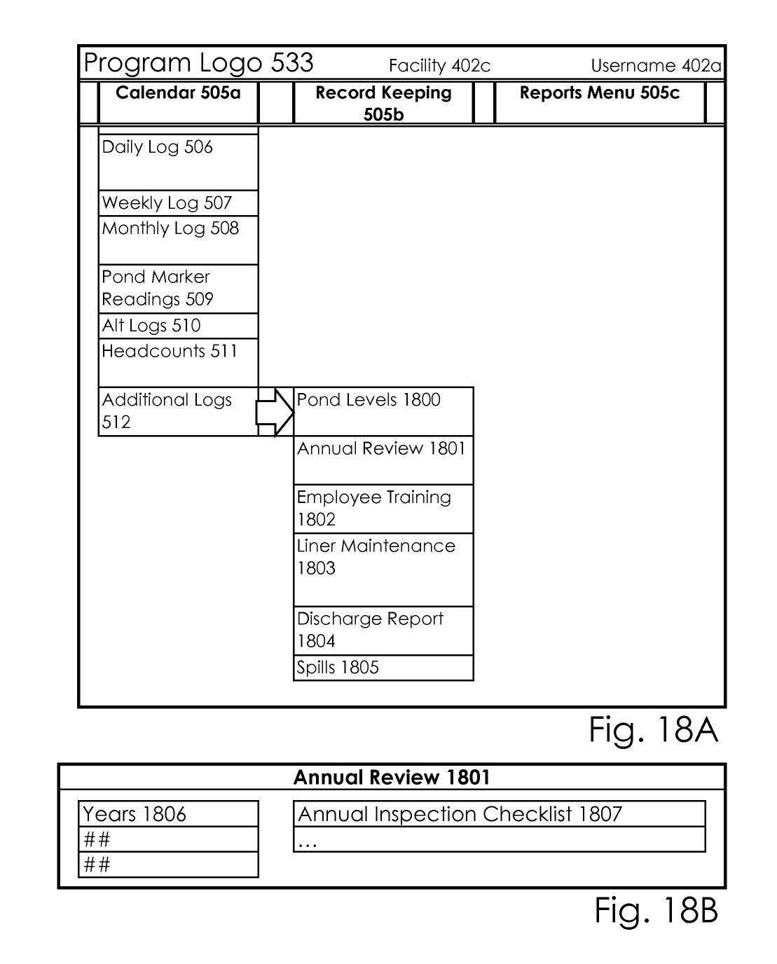

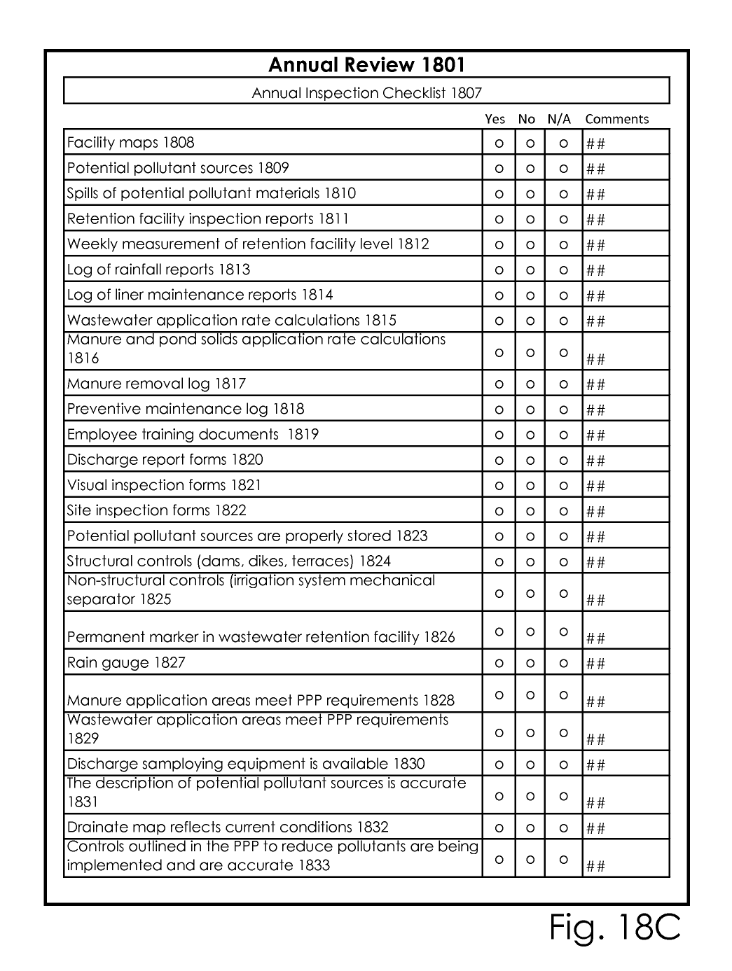

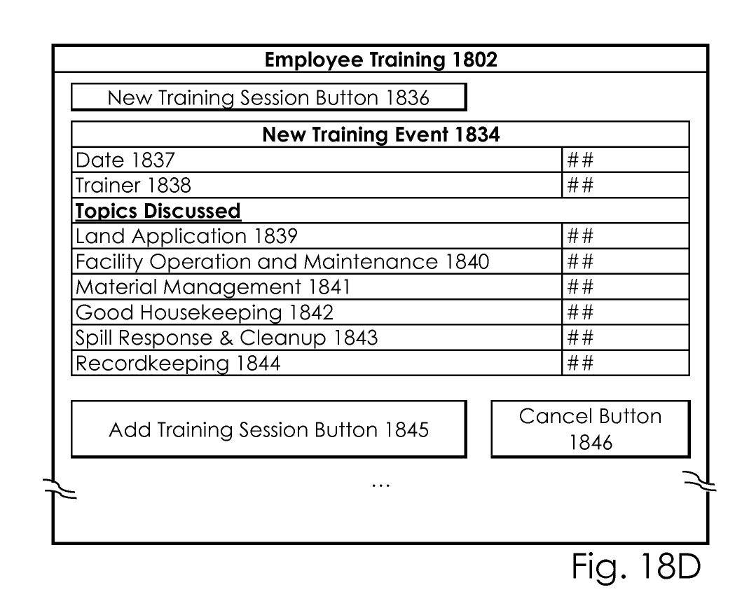

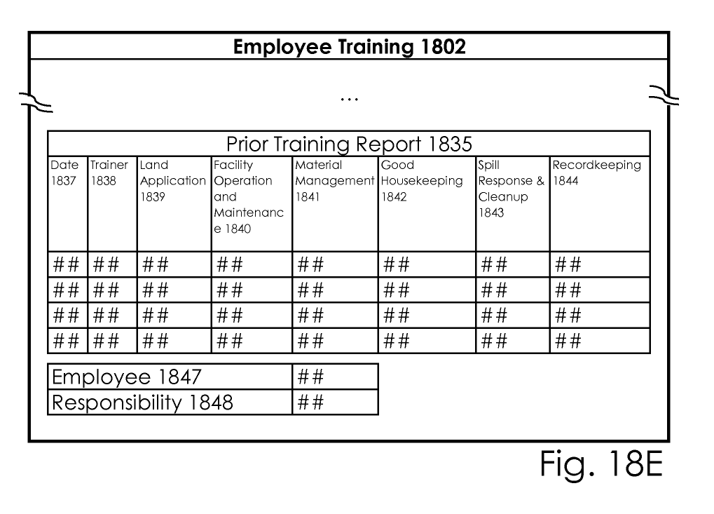

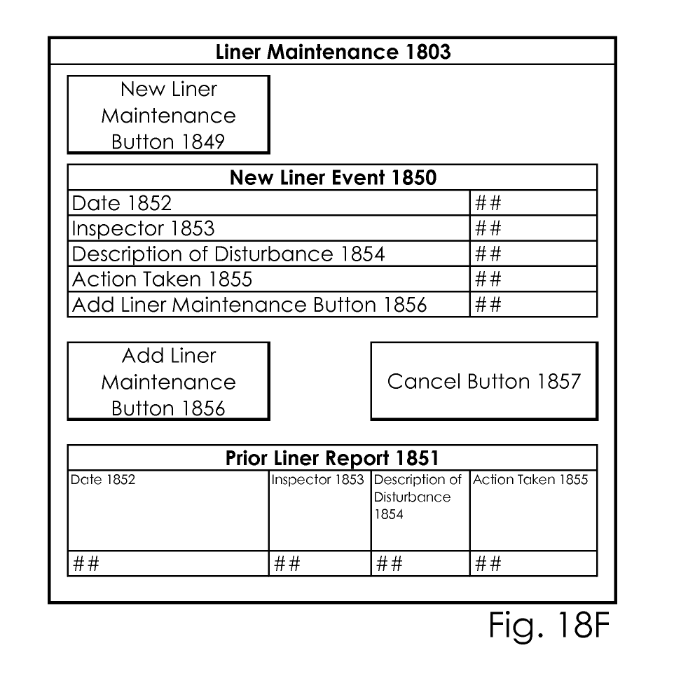

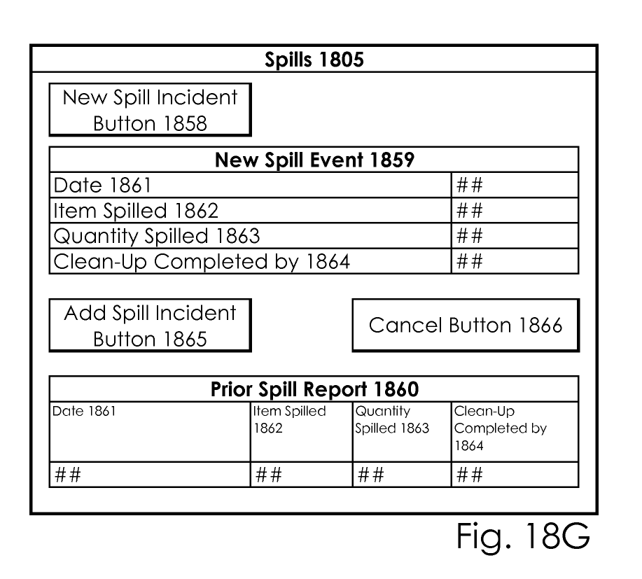

FIG. 18A illustrates additional logs 512 with a plurality of submenu options. In one embodiment, hovering over additional logs 512 can expose a pond levels 1800, an annual review 1801, an employee training 1802, a liner maintenance 1803, a discharge report 1804 and a spills 1805. In one embodiment, said animal operations data management system 100 can generate a one or more reports regarding a state of said animal operations data record 302.

FIGS. 18B and 18C illustrate an overview and detailed view of annual review 1801. In one embodiment, annual review 1801 can comprise a report organized on an annual basis. In one embodiment, annual review 1801 can comprise a years 1806 and an annual inspection checklist 1807.

FIG. 18B illustrates years 1806. In one embodiment, years 1806 can comprise a list of hyperlinked years; wherein, each hyperlink leads to a report for the corresponding year in years 1806.

FIG. 18C illustrates annual inspection checklist 1807. In one embodiment, annual inspection checklist 1807 can comprise a plurality of checklist items 1808-1833 to be filled out annually. In one embodiment, said checklist items 1808-1833 can each comprise a multiple choice portion and a comments section; wherein, said multiple choice portion can comprise a yes option, a no option, and a not applicable option; further wherein, said comments section can receive a text input related to each among said checklist items 1808-1833. In one embodiment, said checklist items 1808-1833 can comprise a facility maps 1808, a potential pollutant sources 1809, a spills of potential pollutant materials 1810, a retention facility inspection reports 1811, a weekly measurement of retention facility level 1812, a log of rainfall reports 1813, a log of liner maintenance reports 1814, a wastewater application rate calculations 1815, a manure and pond solids application rate calculations 1816, a manure removal log 1817, a preventive maintenance log 1818, a employee training documents 1819, a discharge report forms 1820, a visual inspection forms 1821, a site inspection forms 1822, a potential pollutant sources are properly stored 1823, a structural controls (dams, dikes, terraces) 1824, a non-structural controls (irrigation system mechanical separator 1825, a permanent marker in wastewater retention facility 1826, a rain gauge 1827, a manure application areas meet PPP requirements 1828, a wastewater application areas meet PPP requirements 1829, a discharge samploying equipment is available 1830, a the description of potential pollutant sources is accurate 1831, a drainate map reflects current conditions 1832, and a controls outlined in the PPP to reduce pollutants are being implemented and are accurate 1833.

FIGS. 18D and 18E illustrate two portions of employee training 1802. In one embodiment, employee training 1802 can comprise a new training event 1834, a prior training report 1835 and a new training session button 1836.

FIG. 18D illustrates new training event 1834. In one embodiment, pressing said new training session button 1836 can display a portion of new training event 1834 capable of receiving data input. In one embodiment, new training event 1834 can comprise a date 1837, a trainer 1838, a land application 1839, a facility operation and maintenance 1840, a material management 1841, a good housekeeping 1842, a spill response & cleanup 1843 and a recordkeeping 1844. In one embodiment, date 1837 can comprise a date of a training event. In one embodiment, trainer 1838 can comprise a drop down list of trainers capable of receiving a selection among said drop down list of trainers. In one embodiment, said items 1839-1844 can comprise yes/no fields capable of receiving a binary input indicating whether said items 1838-1844 have been accomplished. In one embodiment, new training event 1834 can comprise an add training session button 1845 and a cancel button 1846; wherein, data entered into new training event 1834 can be recorded or erased by clicking add training session button 1845 and/or cancel button 1846, respectively.

FIG. 18E illustrates prior training report 1835. In one embodiment, prior training report 1835 can comprise a date 1837, a trainer 1838, a land application 1839, a facility operation and maintenance 1840, a material management 1841, a good housekeeping 1842, a spill response & cleanup 1843 and a recordkeeping 1844. In one embodiment, prior training report 1835 can comprise records collected with new training event 1834. In one embodiment, each among prior training report 1835 can be expanded to expose an employee 1847 and a responsibility 1848, each comprising details of the corresponding training event.

FIG. 18F illustrates liner maintenance 1803. In one embodiment, liner maintenance 1803 can comprise a new liner maintenance button 1849, a new liner event 1850 and a prior liner report 1851. In one embodiment, clicking on new liner maintenance button 1849 can display new liner event 1850. In one embodiment, new liner event 1850 can receive data related to a new liner event. In one embodiment, a liner can comprise a barrier between the ground and a reservoir of slurry, wastewater, manure, or similar. In one embodiment, new liner event 1850 can comprise a date 1852, an inspector 1853, a description of disturbance 1854, and an action taken 1855. In one embodiment, date 1852 can comprise a date of an inspection conducted by a person (such as said inspector 1853) who collects data related to the nature of the disturbance (description of disturbance 1854), and the action taken to remedy the disturbance (that is, said action taken 1855). In one embodiment, data entered into new liner event 1850 can be recorded or cleared by clicking an add liner maintenance button 1856 and a cancel button 1857, respectively. In one embodiment, prior liner report 1851 can comprise prior records from new spill event 1859, including date 1852, inspector 1853, description of disturbance 1854, and action taken 1855.

FIG. 18G illustrates spills 1805. Spills 1805 can comprise a new spill incident button 1858, a new spill event 1859, and a prior spill report 1860. In one embodiment, clicking new spill incident button 1858 can display new spill event 1859 capable of receiving data related to a spill event. In one embodiment, said spill event can comprise a chemical spill or similar. In one embodiment, new spill event 1859 can comprise a date 1861, an item spilled 1862, a quantity spilled 1863, and a clean-up completed by 1864. In one embodiment, date 1861 can comprise a date of a spill, item spilled 1862 can comprise a chemical spilled, quantity spilled 1863 can comprise a volume of item spilled 1862, and clean-up completed by 1864 can comprise a party having conducted a clean-up of item spilled 1862. In one embodiment, new spill event 1859 can be recorded by clicking an add spill incident button 1865 or cleared by clicking cancel button 1866. In one embodiment, prior spill report 1860 can comprise previously recorded data from new spill event 1859, such as date 1861, item spilled 1862, quantity spilled 1863, and/or clean-up completed by 1864.

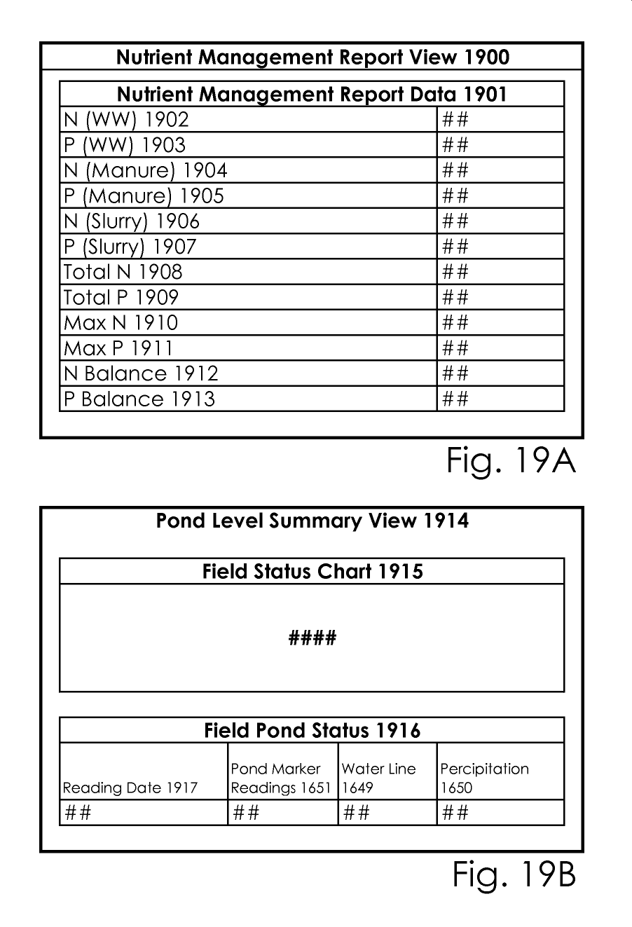

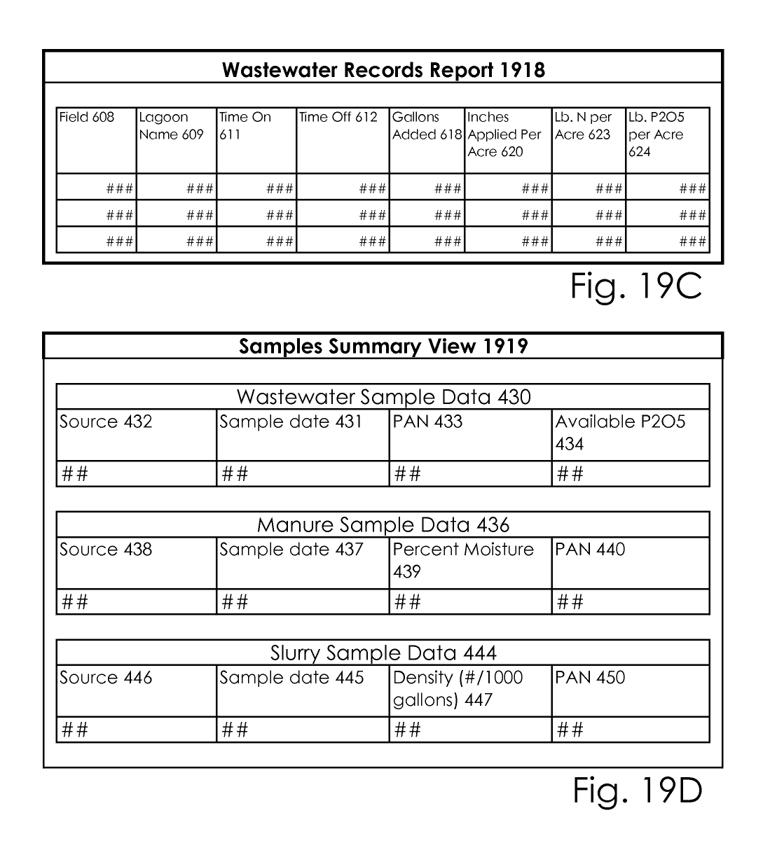

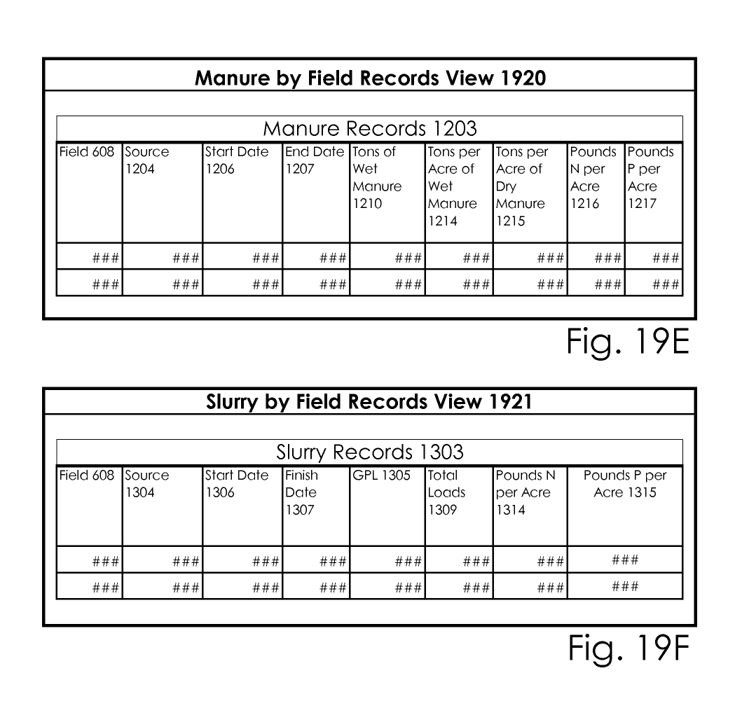

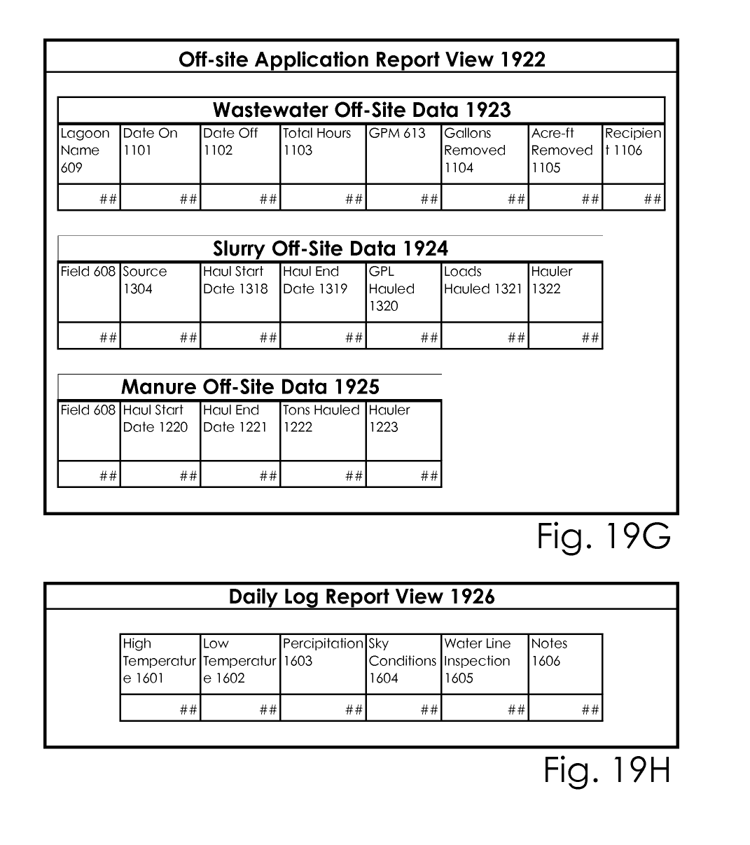

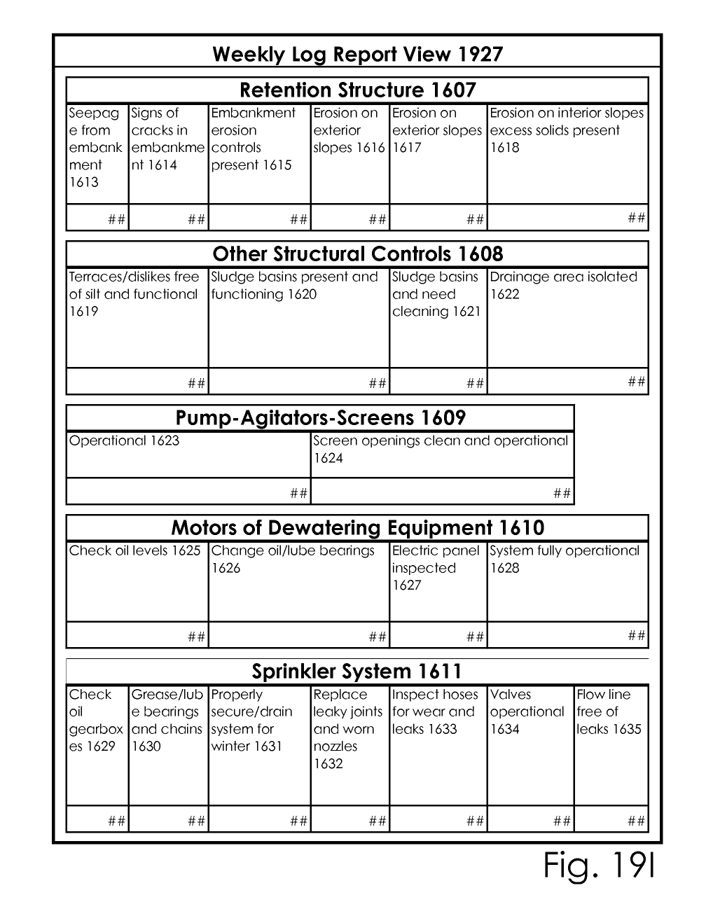

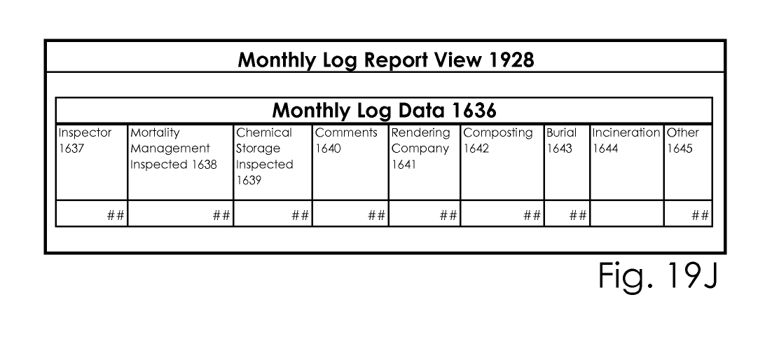

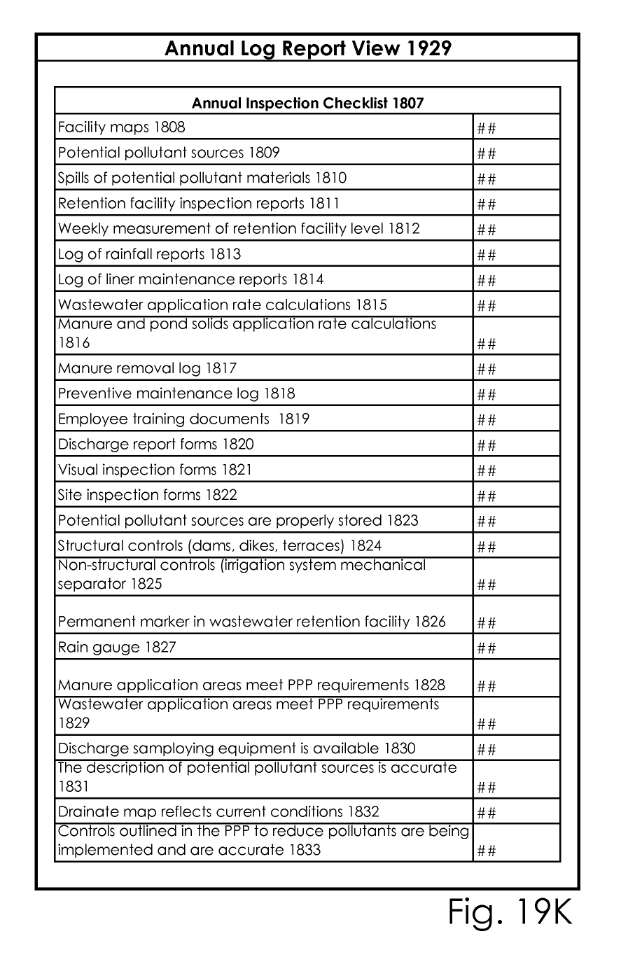

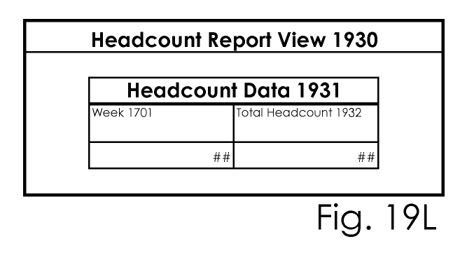

FIGS. 19A-19L can comprise a plurality of reports provided to users of said animal operations data management system 100.

FIG. 19A illustrates a nutrient management report view 1900. In one embodiment, nutrient management report view 1900 can comprise one or more nutrient management report data 1901. Nutrient management report data 1901 can comprise a N (WW) 1902, a P (WW) 1903, a N (manure) 1904, a P (manure) 1905, a N (slurry) 1906, a P (slurry) 1907, a total N 1908, a total P 1909, a max N 1910, a max P 1911, a N balance 1912, and a P balance 1913. In one embodiment, nutrient management report data 1901 can be organized on a field 608 by field 608 basis. In one embodiment, nutrient management report data 1901 can comprise a status of current percent of maximum nutrient 701 in wastewater, manure, slurry, and similar context, as is well known in the field.

FIG. 19B illustrates a pond level summary view 1914. In one embodiment, pond level summary view 1914 cc a view of a current status of a pond and/or field. In one embodiment, pond level summary view 1914 can comprise a field status chart 1915 and a field pond status 1916. In one embodiment, field status chart 1915 can comprise a chart capable of visually displaying data in field pond status 1916. In one embodiment, field pond status 1916 can comprise a reading date 1917, a wastewater records report 1918, a samples summary view 1919, and a manure by field records view 1920. In one embodiment, data can be entered into field pond status 1916 when on a date (such as said reading date 1917) when a pond status is assessed, comprising pond marker readings 1651, water line 1649, and precipitation 1650.

FIG. 19C illustrates a wastewater records report 1918. Wastewater records report 1918 can comprise field 608, lagoon name 609, time on 611, time off 612, gallons added 618, inches applied per acre 620, pounds N per acre 623, and pounds P₂O₅ per acre 624. In one embodiment, wastewater records report 1918 can comprise a report of data collected relevant to wastewater records.

FIG. 19D illustrates a samples summary view 1919. In one embodiment, samples summary view 1919 can comprise data relevant to samples collected regarding wastewater, manure, and slurry. In one embodiment, samples summary view 1919 can comprise wastewater sample data 430, manure sample data 436 and said slurry sample data 444. As discussed, supra, wastewater sample data 430 can comprise source 432, sample date 431, PAN 433, and available P₂O₅ 434; manure sample data 436 can comprise source 438, sample date 437, percent moisture 439, and PAN 440; and said slurry sample data 444 can comprise source 446, sample date 445, density 447, and PAN 450.

FIG. 19E illustrates a manure by field records view 1920. In one embodiment, manure by field records view 1920 can comprise manure records 1203. As discussed, supra, manure records 1203 can comprise field 608, source 1204, start date 1206, end date 1207, tons of wet manure 1210, tons per acre of wet manure 1214, tons per acre of dry manure 1215, pounds N per acre 1216, and pounds P per acre 1217.

FIG. 19F illustrates a slurry by field records view 1921. In one embodiment, slurry by field records view 1921 can comprise slurry records 1303. As discussed, infra, slurry records 1303 can comprise field 608, source 1304, start date 1306, finish date 1307, GPL 1305, total loads 1309, pounds N per acre 1314, and pounds P per acre 1315.

FIG. 19G illustrates an off-site application report view 1922. Off-site application report view 1922 can comprise a wastewater off-site data 1923, a slurry off-site data 1924 and a manure off-site data 1925. In one embodiment, wastewater off-site data 1923 can comprise lagoon name 609, date on 1101, date off 1102, total hours 1103, GPM 613, gallons removed 1104, acre-ft removed 1105, and recipient 1106. In one embodiment, slurry off-site data 1924 can comprise field 608, source 1304, haul start date 1318, haul end date 1319, GPL hauled 1320, loads hauled 1321, and hauler 1322. In one embodiment, manure off-site data 1925 can comprise field 608, haul start date 1220, haul end date 1221, tons hauled 1222, and hauler 1223.

FIG. 19H illustrates a daily log report view 1926. In one embodiment, daily log report view 1926 can comprise high temperature 1601, low temperature 1602, precipitation 1603, sky conditions 1604, water line inspection 1605, and notes 1606.

FIG. 19I illustrates a weekly log report view 1927. Weekly log report view 1927 can comprise retention structure 1607, other structural controls 1608, pump-agitators-screens 1609, motors of dewatering equipment 1610 and sprinkler system 1611. As discussed, infra, retention structure 1607 can comprise seepage from embankment 1613, signs of cracks in embankment 1614, embankment erosion controls present 1615, erosion on exterior slopes 1616, erosion on exterior slopes 1617 and erosion on interior slopes excess solids present 1618; other structural controls 1608 can comprise terraces/dislikes free of silt and functional 1619, sludge basins present and functioning 1620, sludge basins and need cleaning 1621, and drainage area isolated 1622; pump-agitators-screens 1609 can comprise operational 1623 and screen openings clean and operational 1624; motors of dewatering equipment 1610 can comprise check oil levels 1625, change oil/lube bearings 1626, electric panel inspected 1627, and system fully operational 1628; and sprinkler system 1611 can comprise check oil gearboxes 1629, grease/lube bearings and chains 1630, properly secure/drain system for winter 1631, replace leaky joints and worn nozzles 1632, inspect hoses for wear and leaks 1633, valves operational 1634, and flow line free of leaks 1635.

FIG. 19J illustrates a monthly log report view 1928. In one embodiment, monthly log report view 1928 can comprise monthly log data 1636. In one embodiment, monthly log data 1636 can comprise inspector 1637, mortality management inspected 1638, chemical storage inspected 1639, comments 1640, rendering company 1641, composting 1642, burial 1643, incineration 1644, and other 1645.

FIG. 19K illustrates an annual log report view 1929. In one embodiment, annual log report view 1929 can comprise annual inspection checklist 1807. In one embodiment, annual inspection checklist 1807 can comprise items 1808-1833.

FIG. 19L illustrates a headcount report view 1930. In one embodiment, headcount report view 1930 can comprise a headcount data 1931. In one embodiment, headcount data 1931 can comprise week 1701 and a total headcount 1932. In one embodiment, total headcount 1932 can comprise a sum of milkers 1703, dry 1704, young stock 1705 and/or calf hutch 1706.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A method for animal operations data management comprising:
receiving an animal operations data record event from a one or more interface devices related to a concentrated animal feeding operation;
transmitting a first portion of said animal operations data record to a device application;
processing said animal operations data record into a user disposition data with said device application;
transmitting a user disposition record to a storage device in a server; and
storing said user disposition record as one or more event records in said storage device.

2. The method of claim 1 further comprising:
receiving a data related to a projected application event;
generating an after planned application event chart before said projected application event has taken place; and
displaying a before planned application table and said after planned application event table.

3. The method of claim 2 wherein said projected application event comprises a wastewater application event.

4. The method of claim 2 wherein said projected application event comprises a manure application event.

5. The method of claim 2 wherein said projected application event comprises a slurry application event.

6. The method of claim 1 further comprising
calculating a missing logs comprising said animal operations data overdue, and
displaying said missing logs on a notifications display.

7. The method of claim 1 wherein
said animal operations data can further comprise automatically added data; and,
said automatically added data comprises a weather conditions, a date, and a time.

8. The method of claim 1 wherein
said animal operations data can further comprise automatically added data; and,
said automatically added data comprises a conditions recorded with an array of sensors.

9. The method of claim 8 wherein said array of sensors track a pond levels.

10. The method of claim 1 wherein said animal operations data comprises a weekly checklist.

11. The method of claim 1 wherein said animal operations data comprises a weekly animal headcount.

12. The method of claim 1 wherein said animal operations data comprises an employee training log.

13. The method of claim 1 wherein said animal operations data comprises a maintenance log.

14. The method of claim 1 further comprising a record keeping interface comprising a data entry form and one or more tables.

15. The method of claim 14 wherein
said tables comprise a before planned application event table; and,
said before planned application event table displays one or more current application amount from said animal operations data.

16. The method of claim 14 wherein
said tables comprise an after planned application event table; and,
said after planned application event table displays a prediction of one or more predicted application amounts from said animal operations data and a pre-calculation entry.

17. The method of claim 16 wherein
said after planned application event table further comprises a warning graphic; and,
said warning graphic shows one or more critical thresholds for said predicted application amounts.

18. The method of claim 1 further comprising:
generating a one or more reports based on said animal operations data record.

19. The method of claim 18 wherein said one or more reports comprise a field detail screen comprising a summary of animal operations data.

20. The method of claim 18 wherein said one or more reports comprise a samples summary.

21. The method of claim 18 wherein said one or more reports comprise an off-site application summary.

22. The method of claim 18 wherein said one or more reports comprise a pond level summary.

23. The method of claim 18 wherein said one or more reports comprise a daily summary capable of being filtered by a range of dates.

24. The method of claim 18 wherein said one or more reports comprise a weekly summary comprising a weekly checklist.

25. The method of claim 18 wherein said one or more reports comprise a monthly inspectors log summary.

26. The method of claim 18 wherein said one or more reports comprise a headcount summary.

27. The method of claim 18 wherein said one or more reports comprise a monthly inspection report.

28. The method of claim 18 wherein said one or more reports comprise an annual report log.

29. The method of claim 1 further comprising a documents management section comprising a collection of relevant documents for a user.

30. A server comprising a storage device, a processors, a memory, and communication hardware components; and wherein, said server is capable of:
receiving an animal operations data record event from a client device related to a concentrated animal feeding operation,
transmitting a first portion of said animal operations data record to a device application,
processing said animal operations data record into a user disposition data with said device application,
transmitting a user disposition record to a storage device in said server, and
storing said user disposition record as one or more event records in said storage device.

31. A computer usable medium having a computer readable program code embodied therein, wherein the computer readable program code is adapted to be executed to implement the method of claim 1.
